(19) United States
(12) Patent Application Publication
(10) Pub. No.: US 2015/0223914 A1
(43) Pub. Date: Aug. 13, 2015

(54) SELF-LIGATING ORTHODONTIC BRACKET

(71) Applicant: LANCER ORTHODONTICS, INC., Vista, CA (US)

(72) Inventors: Jefferson Sabilla, San Diego, CA (US); Aaron Costello, Chula Vista, CA (US); Albert Ruiz-Vela, Vista, CA (US)

(21) Appl. No.: 14/615,268

(22) Filed: Feb. 5, 2015

Related U.S. Application Data
(60) Provisional application No. 61/937,317, filed on Feb. 7, 2014.

(51) Int. Cl. A61C 7/28; A61C 7/30

(52) U.S. Cl. CPC A61C 7/287; A61C 7/303

(57) ABSTRACT

An orthodontic bracket includes a unitary bracket body and base and an archwire slot for receiving an archwire. A self-ligating gate is mounted on the bracket body and slides from an open position during which an archwire can be mounted in the archwire slot, to a closed position in which the ligating gate retains the archwire in the archwire slot.

### CROSS-REFERENCES TO RELATED APPLICATIONS

This application claims priority to and the benefit of U.S. Provisional Patent Application No. 61/937,317, filed Feb. 7, 2014, the entire disclosure of which is expressly incorporated by reference herein.

### BACKGROUND

Orthodontic bracket bodies have been designed in a variety of geometries or shapes. The most common bracket used in orthodontic treatment has been a twin design, where there are at least two sets of tie wings located at each end of the archslot. These are referred to as the mesial tie wings and the distal tie wings. Ligatures typically pass from the occlusal tie-wings, up and over the archwire/archslot, extending to the gingival tie-wings where they are twisted, cut and tucked under the occlusal tie wings. In this manner ligatures hold the archwire down into the archwire slot. The tie-wings also support other structures such as hooks for elastics and the tie-wings themselves can serve as a sort of macro hook, accepting the loops of elastic chains and the like.

Additionally, other ligature systems fixate orthodontic wire into a bracket archwire slot to enhance orthodontic treatment. These ligature systems often require an alteration or variation of the bracket body design, pad design, slot dimensions or other bracket geometries traditional with a twin tie-wing bracket which have been commonly accepted and proven to work in providing optimal force delivery to complete orthodontic treatment.

Since such a large portion of an orthodontic patient's time in the orthodontist's chair is consumed by changing archwires in this manner, and since such routine archwire changes constitute a major cost to the orthodontic practice and contribute to the cost of treatment for the patient, much inventive effort has gone into identifying innovative chairside systems that reduce the time and cost associated with archwire changing.

One innovation introduced in the mid-1970's was the commercial introduction of elastomeric ligatures. Injection molded from elastomeric polymers such as urethane, elastomeric ligatures form a tiny toroidal “o”-ring shape, and exhibit elastic properties so they can be stretched over the ligation features of an orthodontic bracket. Use of such elastomeric rings introduced some timesavings by eliminating the steps of cutting, tying and tucking of the traditional steel ligatures. Further, the elastomeric ligatures are available in a rainbow of colors as well as clear, black and glow-in-the-dark. Such an array reportedly adds a means for patient self-expression and an element of fun for orthodontic patients.

The use of elastomeric O-rings however introduce new difficulties and concerns. For example, they can discolor and stain and they can lose their tractive force capabilities as they absorb water in the mouth. In general, their biocompatibility, particularly as related to certain plasticizers they may contain to enhance their latex rubber-like properties has been brought into question in the orthodontic literature. Further, like the steel ligatures, the elastomeric ligatures require special dedicated instruments for placement, even though some orthodontists use standard instruments. In either case, any instruments for ligature placement must be sterilized after each use, thus requiring specific in-practice procedures which involve measurable cost.

The present invention is related to yet another path of innovation directed toward mitigating the time-consuming problems and cost associated with routine changing of archwires. Orthodontists have long sought out a bracket design that incorporates features where no ligature whatsoever is required to capture and retain the archwire in the archslot. This has led to the advent of the self-ligating orthodontic bracket. The present invention introduces desirable improvements over conventional self-ligating brackets as described below.

There is a need for a self-ligating orthodontic bracket attachable to the teeth that overcomes the deficiencies of prior art brackets and conventional self-ligating orthodontic brackets.

### SUMMARY OF THE INVENTION

In one embodiment, an orthodontic bracket includes a bracket body configured to be mounted on the teeth and includes an archwire slot having a base, and a base surface, defining a base plane. An archwire is configured for mounting in the archwire slot. In this embodiment, a ligating gate is slidably mounted on the bracket body and movable along a translational plane from an open position to permit insertion of the archwire in the archwire slot, to a closed position wherein the gate extends over the archwire slot to retain the archwire in the archwire slot. The base plane, defined by the bottom surface of the archwire slot, is at an acute angle to the translational plane. In one embodiment, the translational plane is angled 20° with respect to the base plane, however, the angle can range from 15° to 27°. Importantly, when the ligating gate closes, it moves away from the tooth surface, and when the gate moves toward the open position, it moves toward the tooth surface.

In one embodiment, the ligating gate has multiple enhancements to ensure that the archwire is properly retained in the archwire slot and allows for passive archwire correction. The ligating gate has a lead-in radius on its leading edge so that as the gate moves from an open position toward a closed position, the lead-in radius will slide over the archwire in the archwire slot and push the archwire down to help seat the archwire in the slot. The gate has a top surface and a bottom surface, and the bottom surface includes a recess defined by symmetrical projecting edges extending around the outer perimeter of the bottom surface. The symmetrical projecting edges may come into contact with the archwire during adjustment periods, thereby providing mesial-distal contact at two contact points between the projecting edges and the archwire, which improves rotational control. The recess in the bottom of the gate extends at least partially over the archwire slot and provides clearance between the bottom of the gate and the archwire, which may allow for a shallower archwire slot.

In one embodiment, the archwire slot has a first vertical wall and a second vertical wall both extending from a base in the archwire slot, the first vertical wall having an upwardly extending radiused ledge extending in the mesial-distal direction. When the ligating gate is moved from the open position to the closed position, the radiused leading edge of the gate slides over the upwardly extending radiused ledge when the gate moves to the closed position. The leading edge of the ligating gate may extend past the first vertical wall of the archwire slot in the range from 0.001 inch to 0.009 inch.

In one embodiment, an orthodontic bracket includes a bracket body configured to be mounted on teeth and includes an archwire slot having a base, and a base surface, defining a base plane. An archwire is configured for mounting in the archwire slot. In this embodiment, a ligating gate has a top surface, a first side and a second side, and a bottom surface. A post extends outwardly from the bottom surface. A cavity surrounds the post in the bottom surface. Further, the bottom of the gate includes a recess with a recess perimeter extending around the recess. In this embodiment, a first retainer and a second retainer are formed on the bracket body and are used to retain the ligating gate on the bracket. As the ligating gate slides from an open position to a closed position, the first side and the second side of the gate slide within the first retainer and second retainer respectively, as a guide. There may be some frictional resistance between the gate and the first and second retainers when sliding the gate open or closed. A slot in the bracket body has an offset keyhole in the slot and is configured for receiving a post which extends from the bottom of the gate. During assembly of the gate into the first and second retainers, the post is inserted into the offset keyhole and the post then realeasably locks the gate in the open position. As the gate is moved from the open position to the closed position over the archwire slot, the post shifts out of the offset keyhole and slides along the slot thereby applying a slight frictional resistance between the post and the slot as the gate slides to the closed position. As the post in the bottom of the gate extends further along the slot as the gate is closed, the gate locks into place over the archwire slot due to the post engaging a slot opening at the end of the slot. In one embodiment, the post has a chamfer on its end, the chamfer facilitating insertion of the post into the slot when the gate is mounted on the bracket.

The self-ligating gate includes reciprocal opening force mechanics. Typically, self-ligating brackets require a load to be applied directly to the ligating member in order to open the ligating member from the closed position to the open position. This results in forces and moments of inertia applied to the patient's tooth, which can be very uncomfortable to the patient, and it may in fact debond the bracket from the tooth. With the present invention, reciprocal opening force mechanics result in all of the opening forces and moments of inertia be contained in the bracket structure and little to no forces are transmitted to the patient's tooth. This provides for a much more comfortable feel to the patient as the self-ligating gate is moved from the closed position to the open position. To open the gate, an opening tool, similar to a screwdriver, is placed between a bracket body vertical wall and the gate leading edge and rotated or twisted 90° to slide the gate from the closed position to the open position. All of the opening force mechanics are distributed to the bracket body vertical wall and the gate thereby reducing the likelihood of any forces being transferred to the patient's tooth.

In one embodiment, the orthodontic bracket body includes a debonding core which is essentially a recess or cavity extending into the bracket body. The debonding core provides the bracket body with a flexible structure to assist in debonding the bracket from the patient's tooth without causing discomfort to the patient, or injuring the enamel on the tooth. Further, there is a bond base made up of multiple projections that resist shear loading and increase tensile strength, while facilitating debonding the bracket at the end of treatment. In one embodiment, the spacing and surface area of the multiple projections emulates the surface area of an 80 gauge mesh which is known in the art to have superior bonding characteristics in clinical use.

### BRIEF DESCRIPTION OF THE DRAWINGS

FIG. 1 is a top view of an orthodontic bracket body having a tri-wing design.

FIG. 2 is a perspective view depicting an orthodontic bracket body having a tri-wing design.

FIG. 3 is a top perspective view of an orthodontic bracket having an upper hooked bracket configuration.

FIG. 4 is a top perspective view of an orthodontic bracket having a lower hooked bracket configuration in which the ligating gate extends over the archwire slot.

FIGS. 5A-C and 5E are a partial cross-sectional view of an orthodontic bracket depicting various embodiments of the ligating gate in an open position or extending over the archwire slot in the closed position and FIG. 5D is a side view of the bracket depicting the ligating gate closed over the archwire slot.

FIG. 6 is a top view of an orthodontic bracket depicting an offset keyhole and a slot in the bracket body for receiving the post extending from the bottom of the ligating gate.

FIG. 7 is a side view of an orthodontic bracket depicting the archwire slot.

FIGS. 8A and 8B are end views of an orthodontic bracket depicting a first retainer and a second retainer for slidably receiving the ligating gate.

FIGS. 9A-9C are various views depicting the gate in the open position on the orthodontic bracket.

FIG. 10 is a top perspective view of the orthodontic bracket in which the first retainer and the second retainer are visible and partially covering the offset keyhole in the slot.

FIG. 11 is a top view depicting the ligating gate having a first side and a second side.

FIG. 12 is a bottom view of the ligating gate depicting the post, cavity and recess with a recess perimeter.

FIG. 13A is a side view of the ligating gate depicting the post extending from the bottom of the gate and the bottom surface of the gate being planar.

FIG. 13B is a side view of the ligating gate having a first planar surface and a second planar surface at an acute angle to the first planar surface.

FIG. 14 is a side view, partially in cross-section, depicting the ligating gate and the post extending from the cavity in the bottom of the ligating gate.

FIG. 15 is a perspective view of the ligating gate depicting the first side and the second side.

FIG. 16 is a bottom perspective view of a ligating gate depicting the post extending from the bottom of the cavity in the gate, and a recess and recess perimeter extending along a portion of the bottom of the gate.

FIG. 17 is a front view of the ligating gate depicting the post extending from the bottom of the gate.

FIG. 18 is an end view of the ligating gate depicting the post extending from the bottom of the gate.

FIGS. 19A and 19B are partial cross-sectional views of the bracket body depicting the slot and the post positioned in the slot opening as the gate moves from the closed position (FIG. 19A) to the open position (FIG. 19B).

FIGS. 20A and 20B are partial views of the bracket body depicting the slot and the post positioned in the keyhole in the slot to releasably lock the gate in the open position (FIG. 20B) and the closed position (FIG. 20A).

FIG. 21 is a bottom view of the orthodontic bracket base depicting a debonding core extending into the base.

FIG. 22 is a bottom view of the orthodontic bracket base depicting the debonding core extending into the base.

FIG. 23 is a partial perspective view of a bottom of the bracket body of the base of the bracket body depicting the debonding core.

FIGS. 24A-24C are several views of the orthodontic bracket base depicting a breakthrough in the debonding core that includes the full length and width of the core.

FIGS. 25A-25C are various views of the debonding core in the bracket base in which a breakthrough in the debonding core is the full depth of the core, but only a portion of the width of the core.

FIGS. 26A-26C are various views of the bracket base in which a breakthrough in the debonding core is the full width of the core, but only a portion of the depth.

FIGS. 27A-27C are various views of the bracket base in which a breakthrough in the debonding core is only a portion of the depth and a portion of the width of the core.

FIGS. 28A-28B are several views of the orthodontic bracket in which a semi-circular-shaped groove extends around the bracket body.

FIGS. 29A-29B are several views of the orthodontic bracket in which a U-shaped groove extends around the bracket body.

FIGS. 30A-30C are several views of the orthodontic bracket in which a V-shaped groove extends around the bracket body.

FIG. 31 is a partial perspective view of a bottom of the base of the bracket body depicting a bonding core having V-shaped debonding initiators.

FIG. 32 is a partial perspective view of the bottom of the base of the bracket body depicting a rectangular debonding core with no debonding initiators.

FIG. 33 is a partial perspective view of the base of the bracket body depicting a debonding core having an elliptical shape.

FIG. 34 is a partial perspective view of the base of the bracket body depicting a debonding core having longitudinal ridges extending along the bottom surface of the debonding core.

FIG. 35 is a partial perspective view of the base of the bracket body depicting a debonding core having longitudinal grooves in the bottom surface of the core.

FIG. 36 is a partial perspective view of the base of a bracket body in which the debonding core has a parallelogram shape and no rim around the bracket base.

### DETAILED DESCRIPTION OF THE PREFERRED EMBODIMENTS

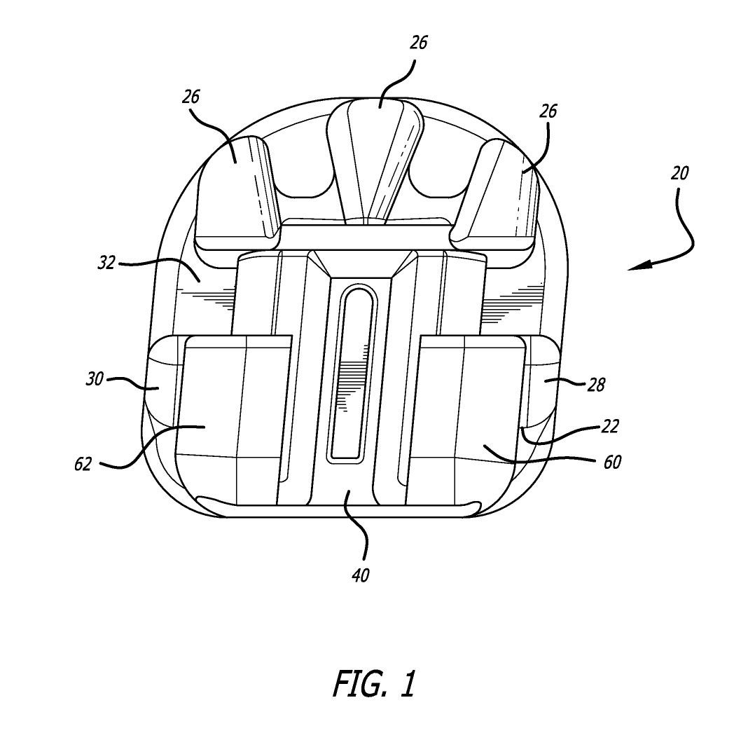

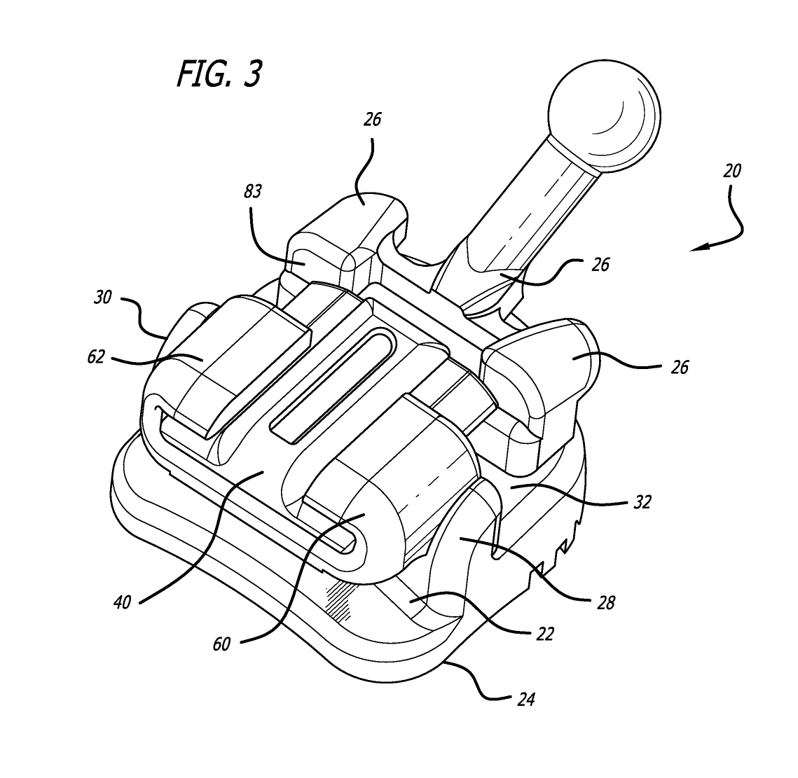

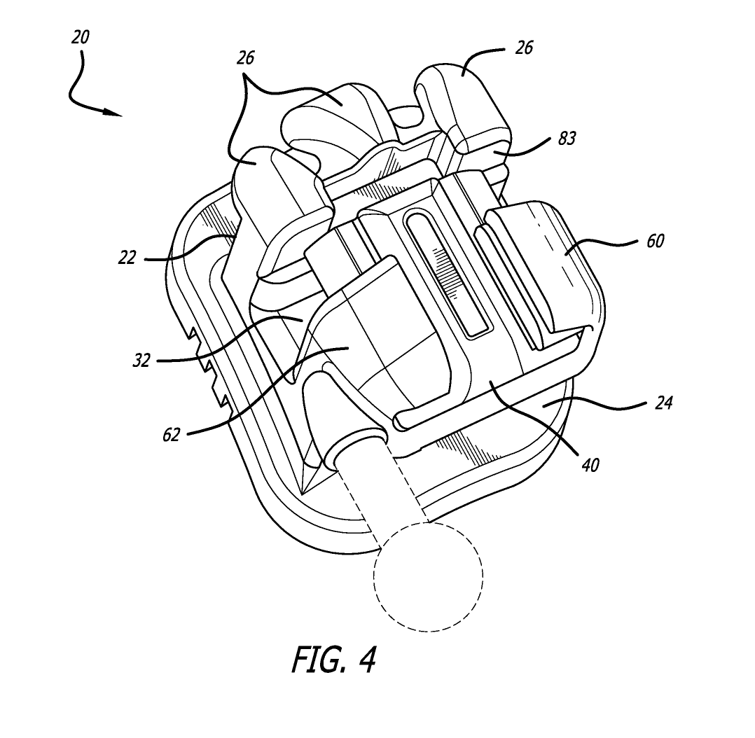

A new bracket design includes a self-ligating gate in order to provide passive archwire correction to a patient's teeth. In keeping with the invention, as shown in FIGS. 1-8, an orthodontic bracket 20 includes a bracket body 22 and a base 24. In this embodiment, the tie wings have a tri-wing design 26 which provides for a low profile in the labial-lingual height of the bracket. One advantage to the tri-wing design 26 is to enable the placement of the elastomeric chain and or traditional ligatures over the archwire slot without contacting the archwire. Importantly, if the elastomeric parts touch the archwire, they will add frictional resistance to the bracket system and thereby impair sliding mechanics. Accordingly, the tri-wing design 26 eliminates the possibility of an elastomeric touching the archwire during the correction process. A tri-wing design 26 on a self-ligating bracket is new and permits the orthodontist to use chain elastic to properly finish treatment without compromising the beneficial sliding mechanics of self-ligating treatment. The orthodontic bracket 20 further includes a mesial shoulder 28 and a distal shoulder 30 which promote passive ligation by not interfering with the archwire in the archwire slot. In other words, the orthodontist can use colored elastics and chain elastic (needed to properly finish treatment) on the shoulders 28,30 without compromising the beneficial sliding mechanics of self-ligating tretment. The shoulders 28,30 keep elastic ligatures off of the archwire. An archwire slot 32 extends through the bracket body 22 in a mesial-distal direction. An archwire 34 is positioned in the archwire slot and can have any configuration including a rectangular cross-section, square cross-section, or round cross-section, any one of which can be used during treatment. Preferably, it is typical that finishing achwires have a rectangular cross-sectional shape for optimum tooth correction.

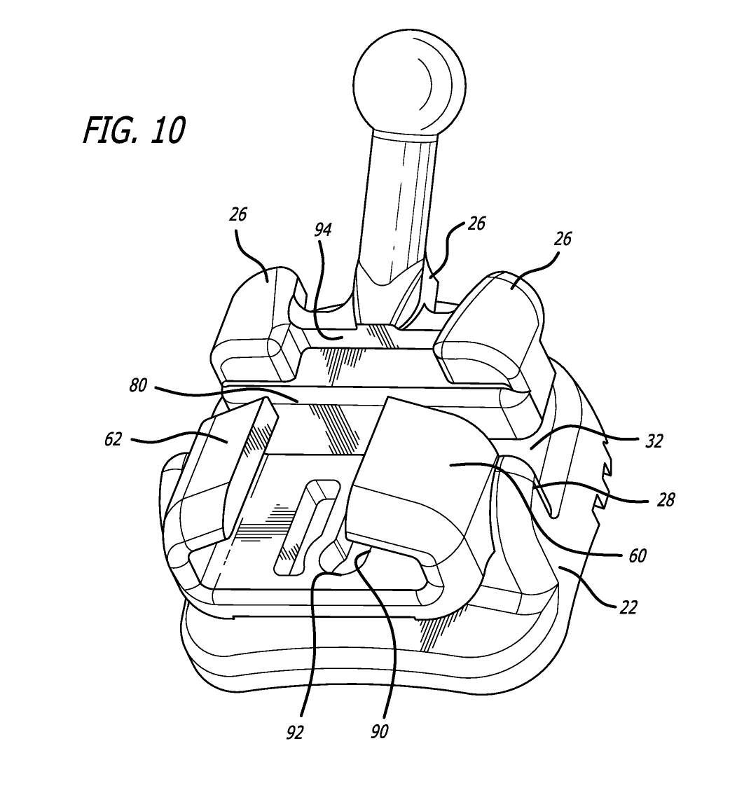

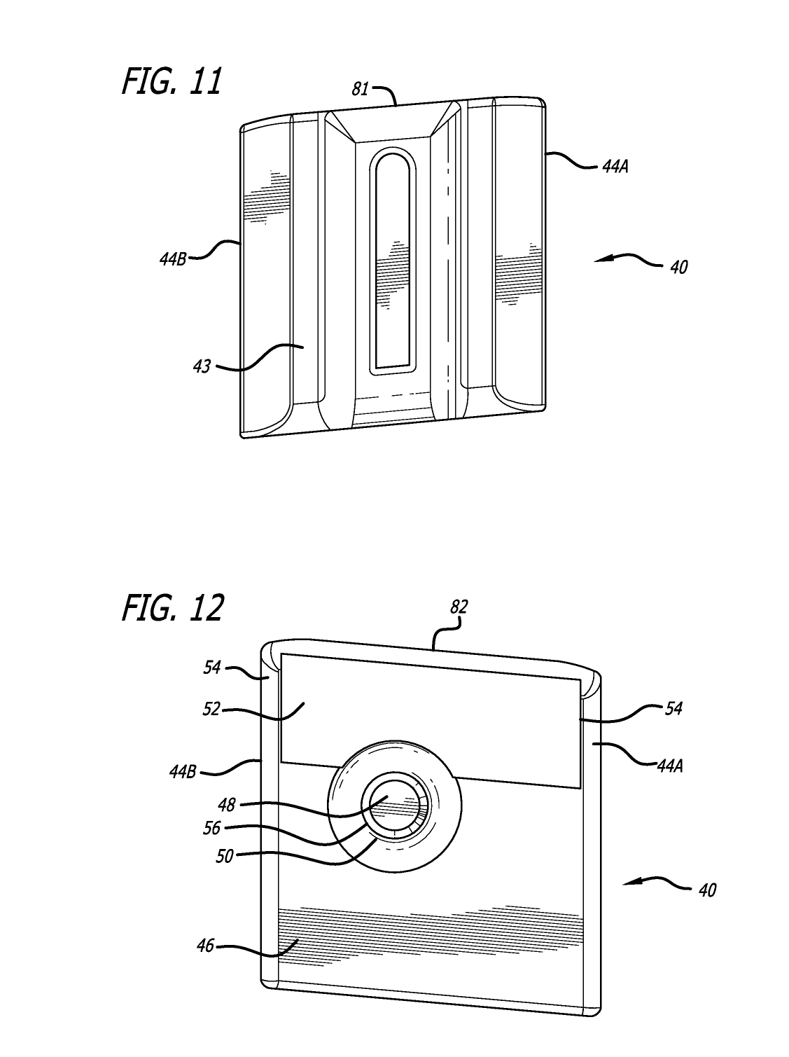

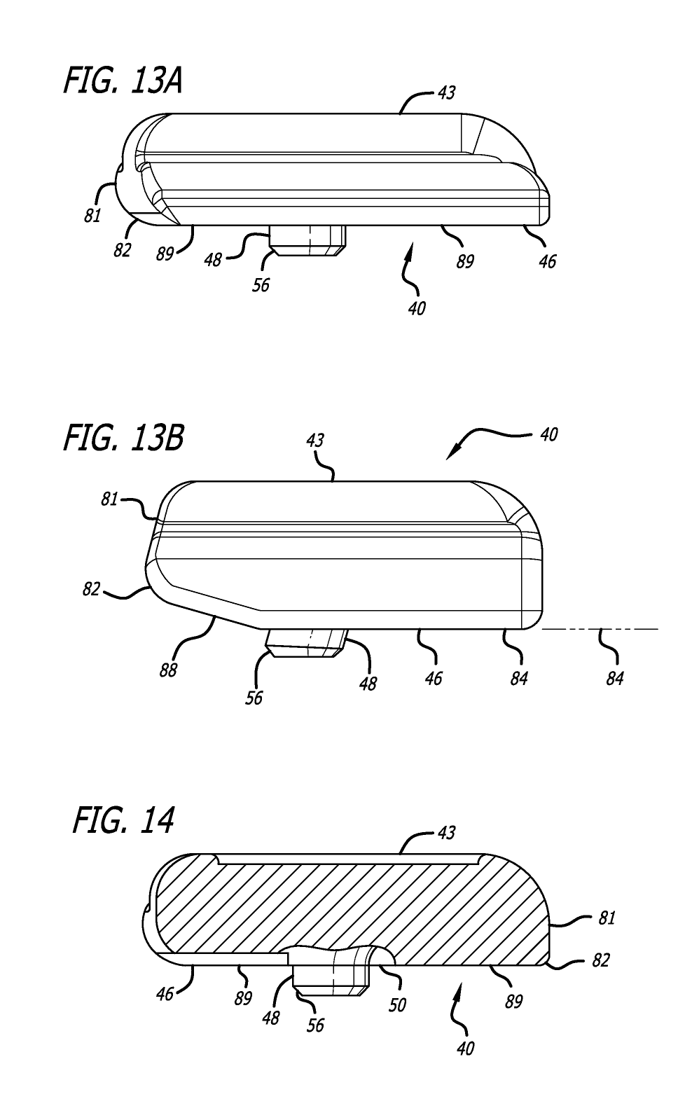

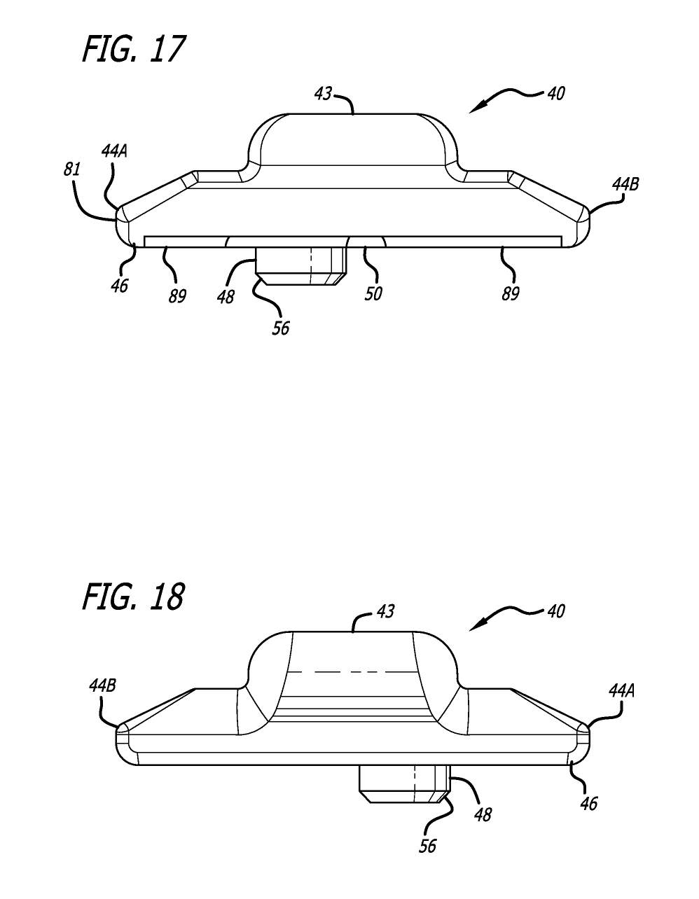

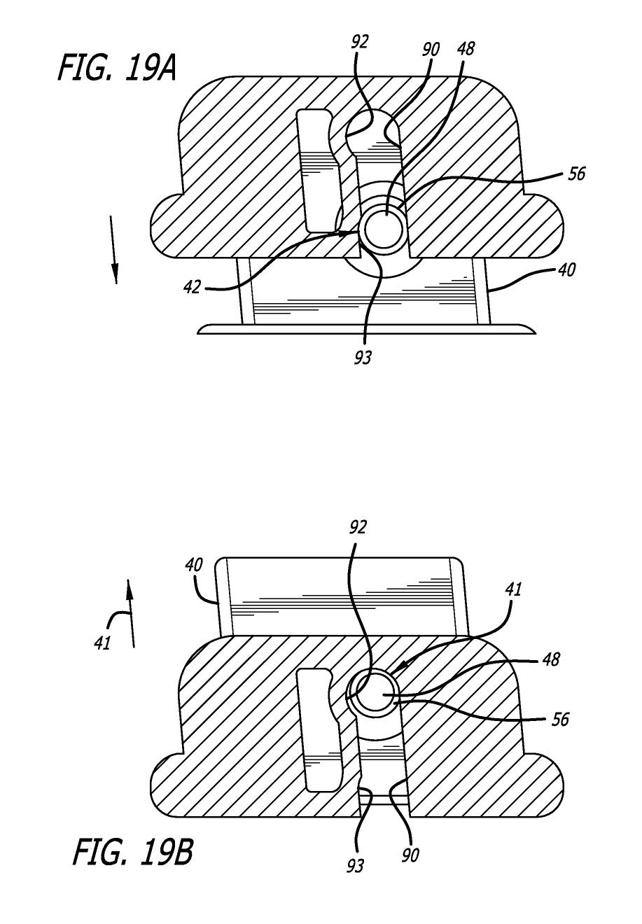

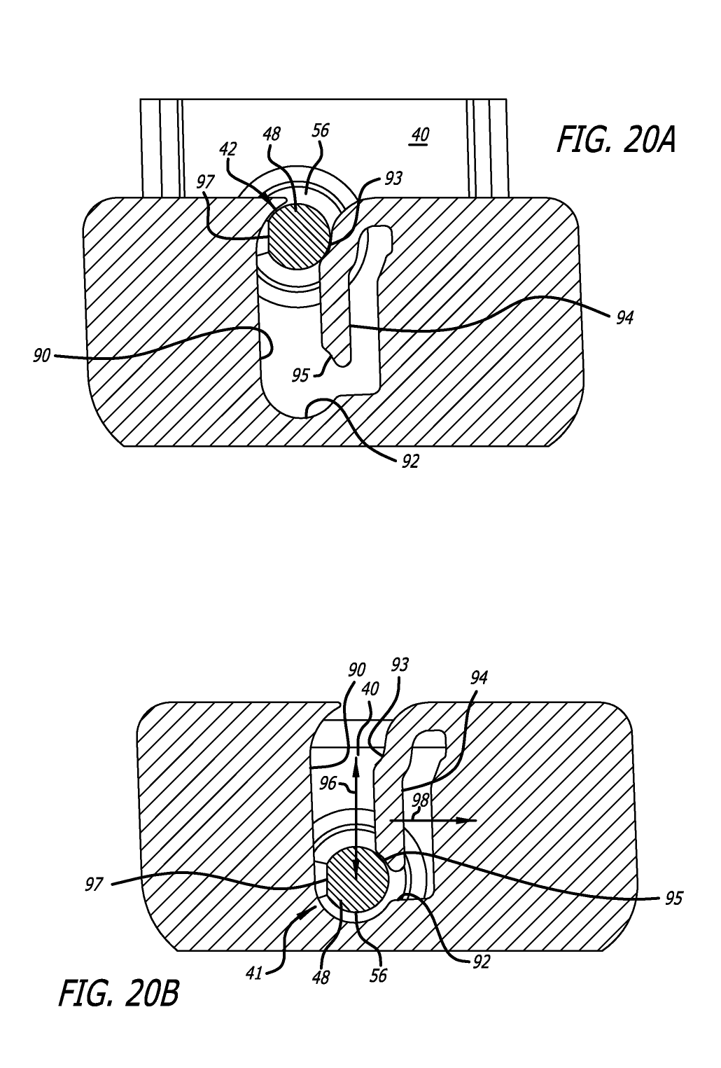

In one embodiment, as further shown in FIGS. 1-20, the orthodontic bracket 20 includes a self-ligating gate 40 that is configured to slide from an open position 41 over the archwire slot 32 to a closed position 42 covering the archwire 34 and closing over the archwire slot. The self-ligating gate 40 includes a top surface 43, a first side 44A and a second side 44B and a bottom surface 46. A post 48 extends outwardly from the bottom surface and is surrounded by cavity 50 in the bottom surface 46. The self-ligating gate 40 further includes a recess 52 that is surrounded by a recess perimeter 54. As can be seen in the drawings, the self-ligating gate 40 is very thin and has a very low labial-lingual height in order to reduce the height of the orthodontic bracket.

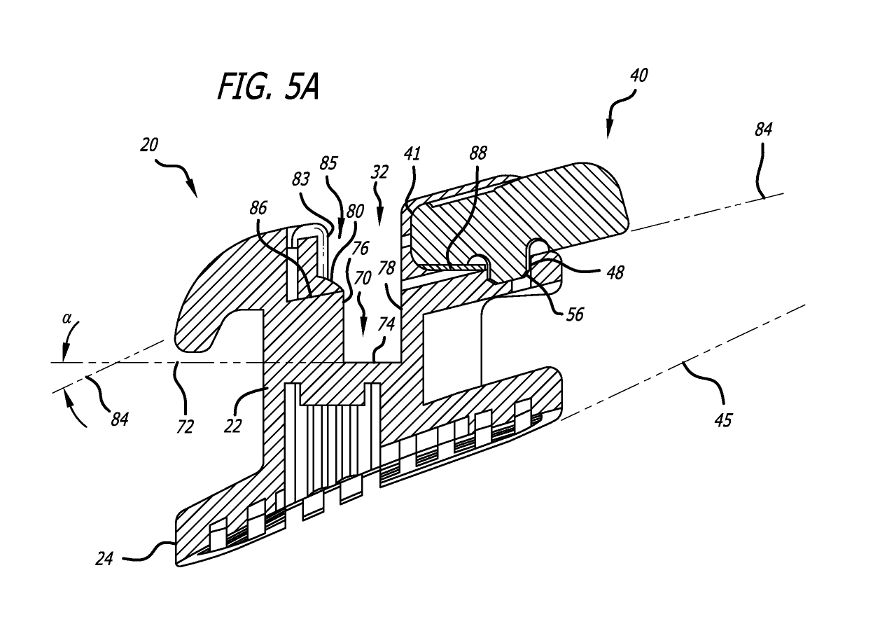

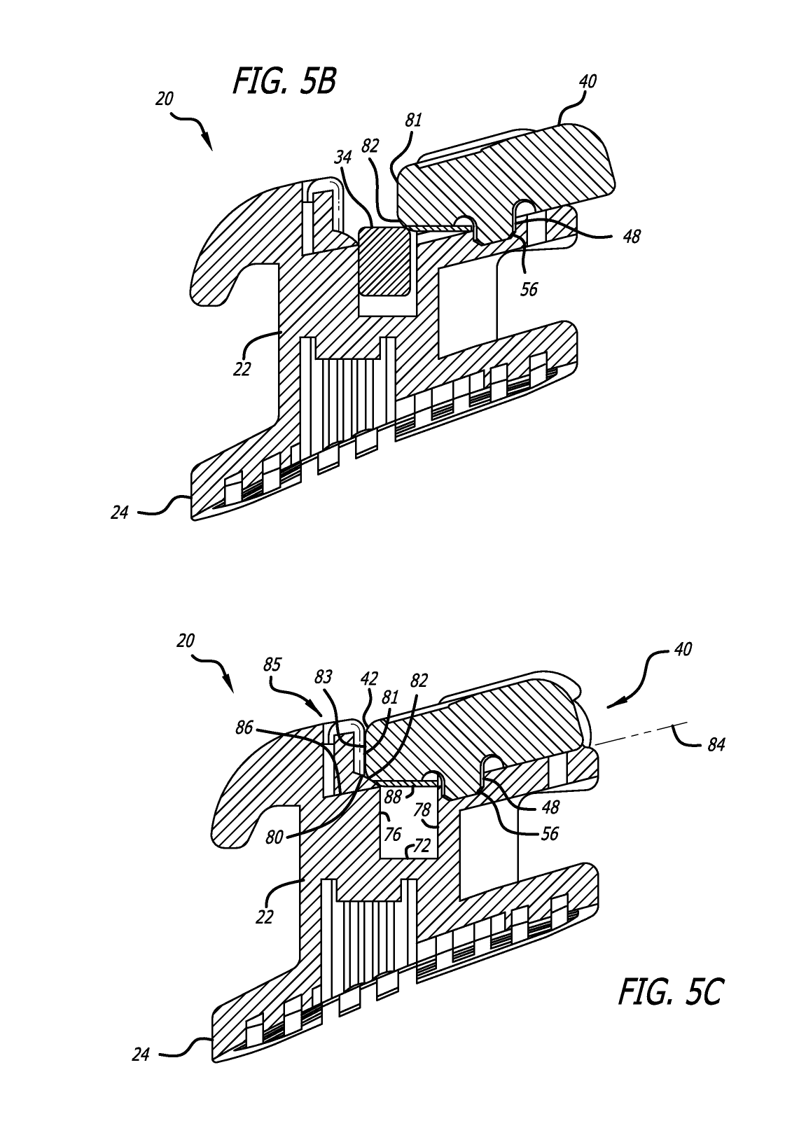

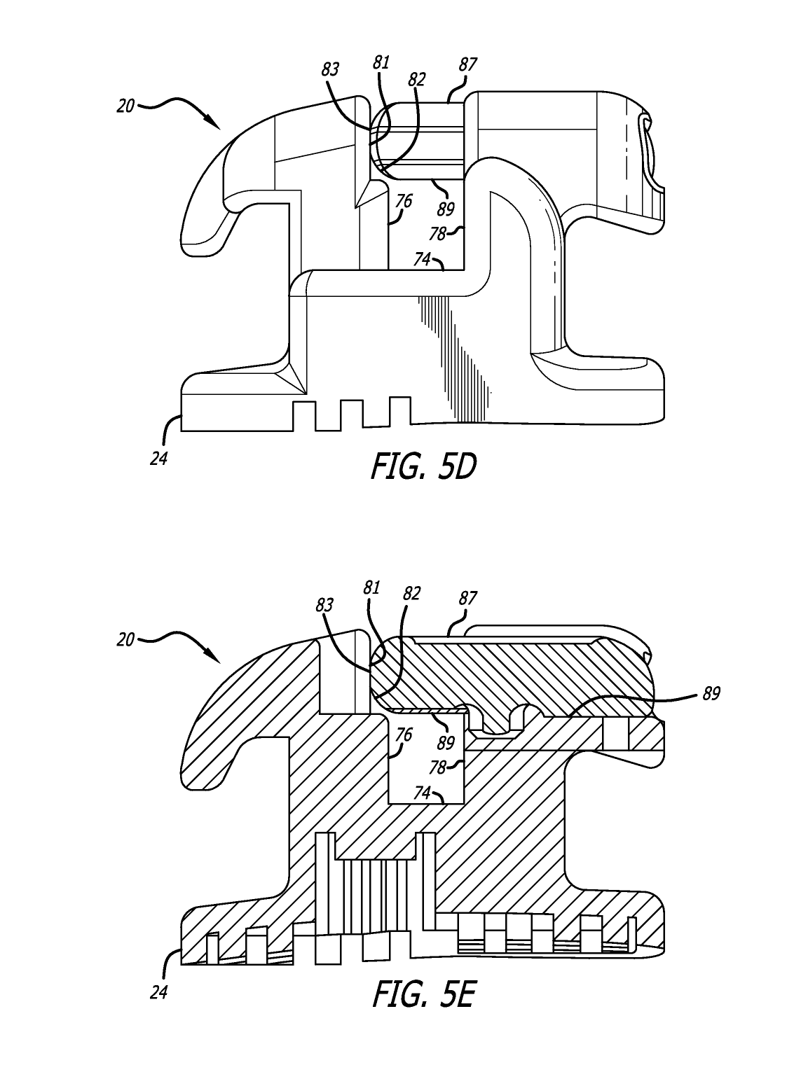

As further shown in FIGS. 1-20, the self-ligating gate 40 is configured to slide over the archwire slot thereby retaining the archwire 34 in the archwire slot. Mounted on the bracket body 22 is a first retainer 60 and a second retainer 62 which have a U-shaped configuration for retaining the self-ligating gate 40. The first and second sides 44A-B slide within the first retainer 60 and the second retainer 62 from an open position 41 shown in FIG. 5A to a closed position 42 shown in FIG. 5C. In this embodiment, the archwire slot 32 has an archwire slot base 70 that includes a base plane 72 that is defined by the bottom surface 74 of the archwire slot base 70. A first vertical wall 76 and a second vertical wall 78 extend upwardly (in a labial direction) from the archwire slot base 70. At the top of the first vertical wall 76 is an upwardly extending radiused ledge 80 that extends in a mesial-distal direction along the length of the first vertical wall and is radiused to bulge outwardly (in a labial direction), up and away from the archwire slot. In one embodiment, the upwardly extending radiused ledge has a radius of 0.005 inch, but this radius can vary depending upon different angulated brackets used in the treatment process. When the self-ligating gate 40 is moved from the open position 41 as shown in FIG. 5A, to the closed position 42 as shown in FIG. 5C, the gate leading edge 81 will come into close proximity with the tie wing wall 83 which rises above the upwardly extending radiused ledge 80 in order to insure that the leading edge 81 of the gate overtravels the first vertical wall 76 of the archwire slot. Importantly, the self-ligating gate 40 has a radiused leading edge 82 that extends toward, but does not contact, the upwardly extending radiused ledge 80 to further ensure a smooth closing position of the gate over the archwire slot. The radiused leading edge 82 of the gate preferably has a radius of 0.008 inch, but other radii are contemplated to serve a particular need. As the self-ligating gate 40 moves from the open position 41 to the closed position 42, the radiused leading edge 82 will slide over the top of the archwire 34 thereby helping to push the archwire into the archwire slot to make sure it is properly seated in the slot. It is important to note that the radiused leading edge 82 is in fact a radiused edge, and not a chamfered edge.

In one embodiment, as shown in FIGS. 1-5C, the self-ligating gate 40 defines a translational plane 84. More particularly, the bottom surface 46 of the ligating gate 40 defines a planar surface that forms the translational plane 84. Further, the base plane 72, defined by the bottom surface 74 of the archwire slot base 70, defines a base plane that is at an acute angle with respect to the translational plane. In one embodiment, the translational plane 84 is angled approximately 20° with respect to the base plane. With a 20° acute angle between the translation plane 84 and the base plane 72, there is ample room to maintain good under tie wing space without radically increasing the labial-lingual height of the bracket.

As shown in FIGS. 5A-5C, the torque plane 45 is at 22° and the translational plane 84 is at 15° so that as the gate moves from the open position 41 to the closed position 42, the gate moves away from the tooth surface. When the self-ligating gate 40 moves toward the closed position 42 it moves away from the tooth surface and when the gate moves towards the open position 41, it moves toward the tooth surface.

In one embodiment of the self-ligating gate, as shown in FIGS. 5A-5C, the bottom surface 46 of the ligating gate 40 defines two planar surfaces, the first being the translational plane 84, and the second being archwire slot plane 88. In this embodiment, the translational plane 84 is angled approximately 20° to the base plane. In contrast, the archwire slot plane 88 is parallel to the base plane 72 of the archwire slot 32. In other words, the archwire slot plane 88, which extends over the archwire slot 32 when the gate 40 is in the closed position 42, is parallel to the bottom of the archwire slot, namely the base plane 72. Since in finishing orthodontic treatments, the archwire 34 has a rectangular cross-section, the archwire slot plane 88 will be parallel to the upper surface of the archwire in the archwire slot. As shown in FIGS. 5A-5E, the archwire slot plane 88 on the bottom surface of 46 of the gate 40 is parallel to the base plane 72 of the archwire slot 32, however, the upwardly extending radiused ledge 80 is non-parallel to both the archwire slot plane 88 and the base plane 72. This angular (non-parallel) relationship more readily allows the leading edge 82 of the gate 40 to overtravel the first vertical wall 76 when the gate is closed.

In an alternative embodiment regarding the ligating gate, as shown in FIGS. 5D-5E, the ligating gate 40 has bottom surface 46 configured as a planar surface 89 with no angulations as previously discussed in other embodiments. The planar surface 89 is not angled so that as the ligating gate 40 extends over the archwire slot, the entire planar surface 89 is parallel to the base plane 72 of the archwire slot 32.

In one embodiment, as shown in FIGS. 1-4 and 9C, the orthodontic bracket 20 has a bracket body 22 which includes an archwire slot 32 that extends in a mesial-distal direction. In this embodiment, the archwire slot has radiused edges 100 on the mesial-distal edges of the archwire slot in order to reduce the resistance as the archwire slides over the corners on severely rotated teeth.

The self-ligating gate 40 as shown in FIGS. 1-20, includes reciprocal opening force mechanics. Typically, self-ligating brackets require a load to be applied directly to the ligating member in order to open the ligating member from the closed position to the open position. This results in forces and moments of inertia applied to the patient's tooth, which can be very uncomfortable to the patient, and it may in fact debond the bracket from the tooth. With the present invention, reciprocal opening force mechanics result in all of the opening forces and moments of inertia be contained in the bracket structure and little to no forces are transmitted to the patient's tooth. This provides for a much more comfortable feel to the patient as the self-ligating gate 40 is moved from the closed position 42 to the open position 41. To open the gate (see FIG. 5C), an opening tool (not shown), similar to a screwdriver, is placed in tool slot 85 between a bracket body vertical wall 94 wall and the gate leading edge 81 and rotated or twisted 90° to slide the gate 40 from the closed position to the open position. The bottom surface 86 of the tool slot 85 is angled relative to the archwire slot plane 88 and the base plane 72 so that the opening tool does not bind in the tool slot. The dimensions of the tool slot 85 can vary depending on the bracket size and shape. In one embodiment, the width of the tool slot 85 in the mesial/distal direction is in the range of 0.035 inch to 0.060 inch. Further, measuring from vertical wall 94 of the tool slot 85 to the far side of the second vertical wall 78 of the archwire slot 32 is in the range of 0.030 inch to 0.060 inch. The dimensions will ensure the proper reciprocal-force opening mechanics to move the gate 40 from the closed position 42 to the open position 41 without placing undue stress on the bracket body 22 and the patient's tooth. All of the opening force mechanics are distributed to the bracket body vertical wall 94 and the gate 40 thereby reducing the likelihood of any forces being transferred to the patient's tooth.

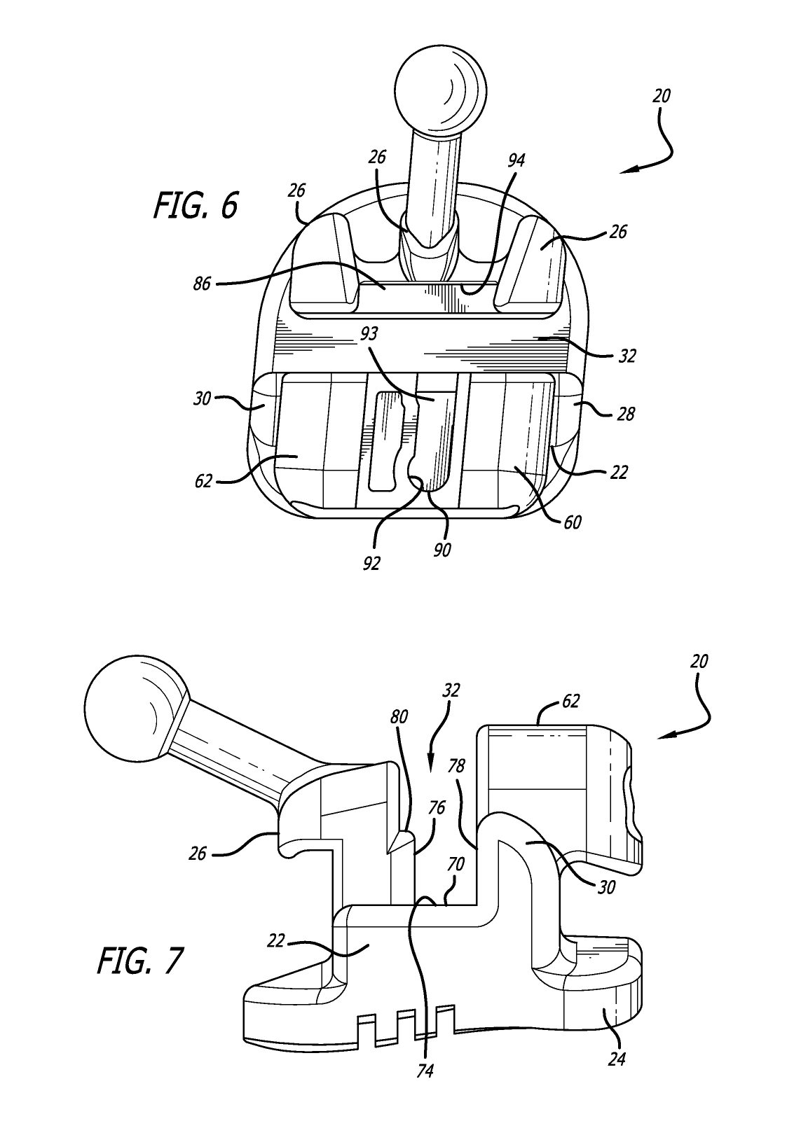

In one embodiment, as shown in FIGS. 6, 10, 13A, 13B, 16 and 19A and 19B, the self-ligating gate moves from an open position 41 to a closed position 42 over the archwire slot 32 and locks in place in the closed position. To assist in locking the gate 40 in the closed position, a slot 90 in the bracket body 22 is configured to receive the post 48 extending from the bottom surface 46 of the ligating gate 40. In other words, the post 48 slides in the slot 90 as the gate is moved from the open position to the closed position, and vice versa. The slot 90 has an offset keyhole 92 which also receives the post 48. During assembly of the gate 40 into the first retainer 60 and the second retainer 62, the post is inserted into the slot. Alternatively, the post 48 has a chamfer 56 formed at the end of the post so that when mounting the gate on the bracket, the chamfer 56 facilitates insertion of the post into the slot. In the open position, the post 48 extends into the offset keyhole 92, which in one embodiment is an arcuate surface having approximately the same curvature as the outer surface as the post. Using finger pressure to push the gate, as the self-ligating gate 40 is moved from the open position toward the closed position, the post slides slightly to one side and out of the offset keyhole 92 and into the slot 90. The slot 90 is configured so that as the gate continues to move from the open position toward the closed position, there is a slight frictional engagement between the post and the slot so that in the closed position, there is a positive feel as the gate moves to the closed position. As the gate reaches the closed position 42, the post 48 slides into a slot opening 93 at the end of slot 90, which provides a releasable locking of the gate in the closed position. In one embodiment, there is an audible clicking sound indicating the post 48 has shifted into the slot opening 93 to releasably lock the gate in the closed position 42. In one embodiment, the slot opening 93 has an arcuate surface that approximates the curvature of the outer surface of the post. With the gate 40 in the closed position 42, the gate leading edge 81 is in close proximity to the tie wing wall 83 above the upwardly extending radiused ledge 80. In fact, it is desired that the leading edge 81 of the gate extend past the first vertical wall 76 of the archwire slot 32 to ensure that the self-ligating gate 40 extends all the way across the archwire slot thereby retaining the archwire 34 in the slot. The leading edge 81 might extend from 0.001 inch to 0.009 inch past the first vertical wall 76 of the archwire slot when the gate is in the fully closed position over the archwire slot. In one embodiment, the leading edge 81 of the gate extends 0.005 inch past the first vertical wall 76 of the archwire slot when the gate is in the closed position 42.

In one embodiment, as shown in FIGS. 6, 10, 13A-13B, 20A and 20B, the self-ligating gate 40 moves from an open position 41 to a closed position 42 over the archwire slot 32 and locks in place in the closed position. To assist in locking the gate 40 in the closed position, a slot 90 in the bracket body 22 is configured to receive the post 48 extending from the bottom surface 46 of the ligating gate 40. In other words, the post 48 slides in the slot 90 as the gate is moved from the open position 41 to the closed position 42, and vice versa. In one embodiment, post 48 has a flat surface 97 that engages slot 90 and provides stability as the gate 40 moves in the slot. In other words, the slot 90 has a flat surface that mates with flat 97 of the post 48 to add support and stability as the post slides in the slot. The slot 90 has an offset keyhole 92 which also receives the post 48. During assembly of the gate 40 into the first retainer 60 and the second retainer 62, the post 48 is inserted into the slot 90. Alternatively, the post 48 has a chamfer 56 formed at the end of the post so that when mounting the gate on the bracket, the chamfer 56 facilitates insertion of the post into the slot. In the open position 41, the post 48 extends into the offset keyhole 92, which in one embodiment is an arcuate surface having approximately the same curvature as the outer surface as the post. Using finger pressure to push the gate, as the self-ligating gate 40 is moved from the open position 41 toward the closed position 42, the post slides slightly to one side and out of the offset keyhole 92 and into the slot 90. A spring arm 94 forms part of the slot 90 and as the post 48 slides in the slot the spring deflects slightly in the direction of arrow 98, which is in a transverse direction to the length of the slot. The spring arm 94 provides slight engagement forces on the post 48 as the gate 40 slides from the open to closed positions. Thus, there is a slight, but perceptible, frictional engagement between the post 48 and slot 90 due to the spring action of the spring arm 94. A curved edge 95 at the end of spring arm 94 provides relief for the post 48 to move in and out of offset keyhole 92. The slot 90 is configured so that as the gate continues to move from the open position toward the closed position, the post 48 moves linearly in the direction of arrow 96. As the gate reaches the closed position 42, the post 48 slides into a slot opening 93 at one end of slot 90, which provides a releasable locking of the gate in the closed position. In one embodiment, there is an audible clicking sound indicating the post 48 has shifted into the slot opening 93 to releasably lock the gate in the closed position 42. In one embodiment, the slot opening 93 has an arcuate surface that approximates the curvature of the outer surface of the post. With the gate 40 in the closed position 42, the gate leading edge 81 is in close proximity to the tie wing wall 83 above the upwardly extending radiused ledge 80. In fact, it is desired that the leading edge 81 of the gate extend past the first vertical wall 76 of the archwire slot 32 to ensure that the self-ligating gate 40 extends all the way across the archwire slot thereby retaining the archwire 34 in the slot. The leading edge 81 might extend from 0.001 inch to 0.009 inch past the first vertical wall 76 of the archwire slot when the gate is in the fully closed position over the archwire slot. In one embodiment, the leading edge 81 of the gate extends 0.005 inch past the first vertical wall 76 of the archwire slot when the gate is in the closed position 42.

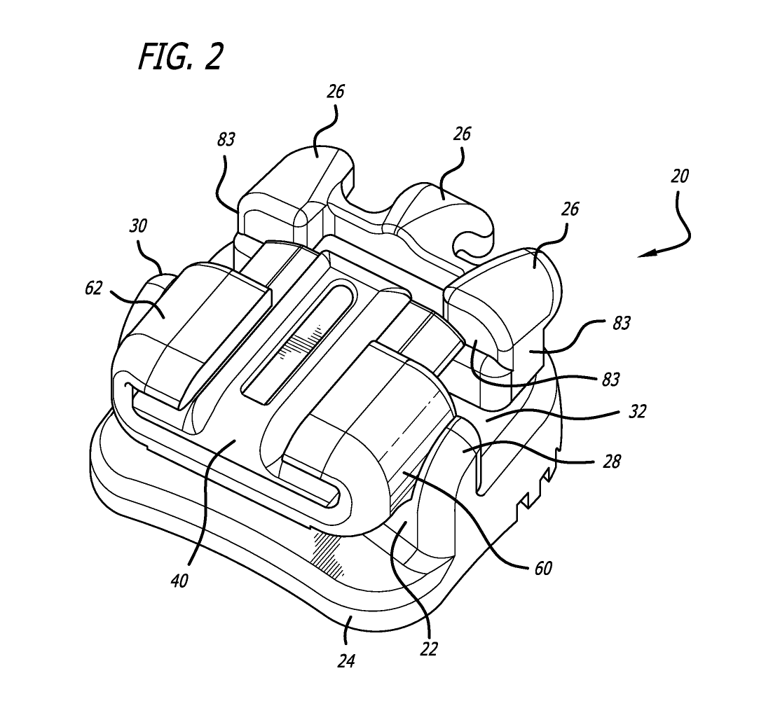

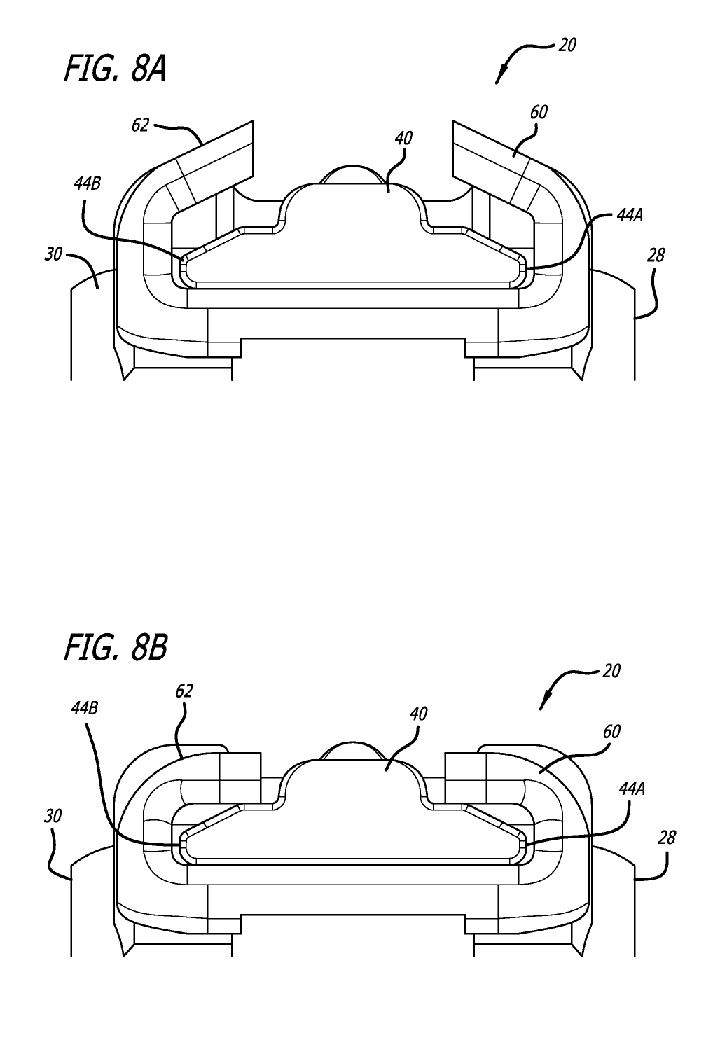

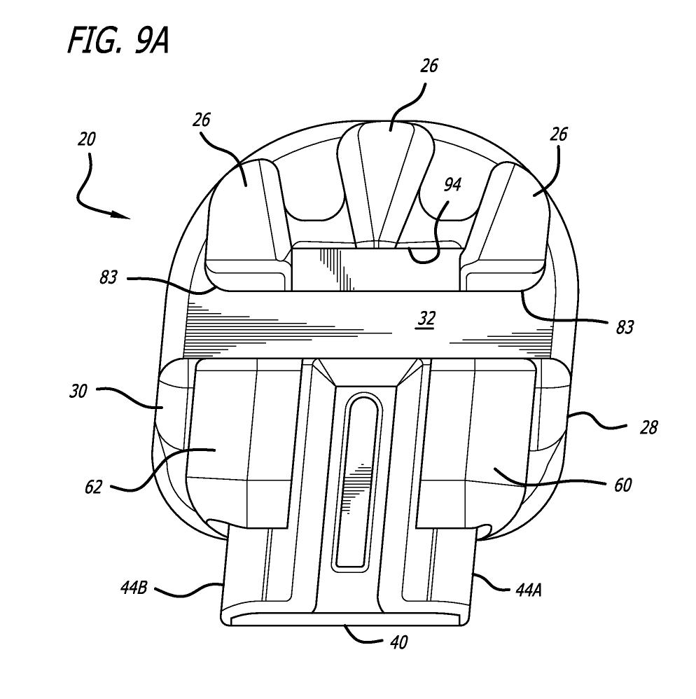

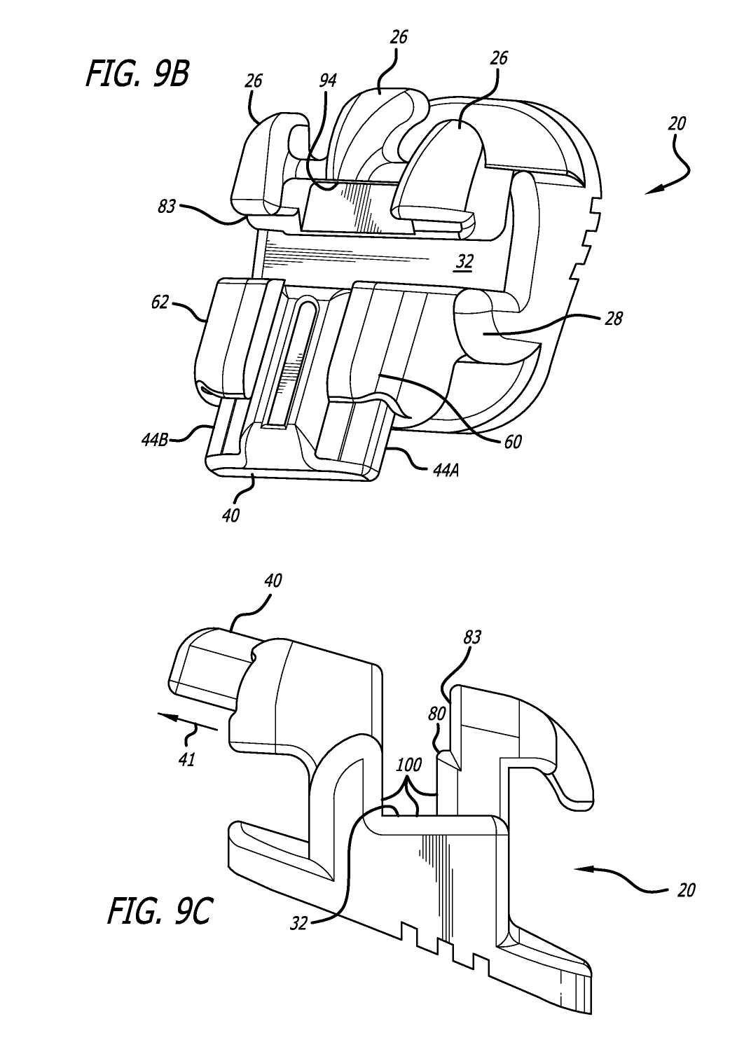

In one embodiment, as shown in FIGS. 1-20, and in particular, in FIGS. 8A, 8B, 10 and 17, the orthodontic bracket 20 has a bracket body 22 which includes a first retainer 60 and a second retainer 62 which are retainers to hold the ligating gate 40. In this embodiment, as shown for example in FIGS. 8A, 8B, first retainer 60 and second retainer 62 are formed at a 45° angle toward an open position in order to receive the gate 40. The gate 40 is inserted in between the first and second retainers 60,62 and moved toward the closed position until the gate is in the fully closed position 42. The first and second retainers 60,62 can be pressed downwardly onto gate 40 using any type of press capable of bending the retainers tightly onto the gate as shown in FIG. 8B. The first and second retainers 60,62 are pressed onto the gate 40 and move from the 45° angle in the open position to a 0° or less angle (i.e., not parallel to the gate) when pressed closed onto the gate. Optionally, the first and second retainers 60,62 can be subjected to a cold forming process in order to form the first and second retainers over the ligating gate. In other words, the ligating gate 40 is used as a mold for the retainers 60,62 to tightly form onto the ligating gate first side 44A and second side 44B. After bending retainers 60,62 and/or after the cold forming process, there will be a slight spring-back in retainers 60,62 thereby allowing free movement of the gate within first retainer 60 and second retainer 62. There may be a slight frictional engagement between the gate and the first and second retainers, however, the gate should move freely from the open position 41 to the closed position 42, and vice versa. Thus, as shown for example in FIGS. 2 and 9B, the ligating gate 40 is slidably retained within the first retainer 60 and the second retainer 62 so that the gate can move freely, yet with some slight frictional resistance, when opening and closing the gate over the archwire slot.

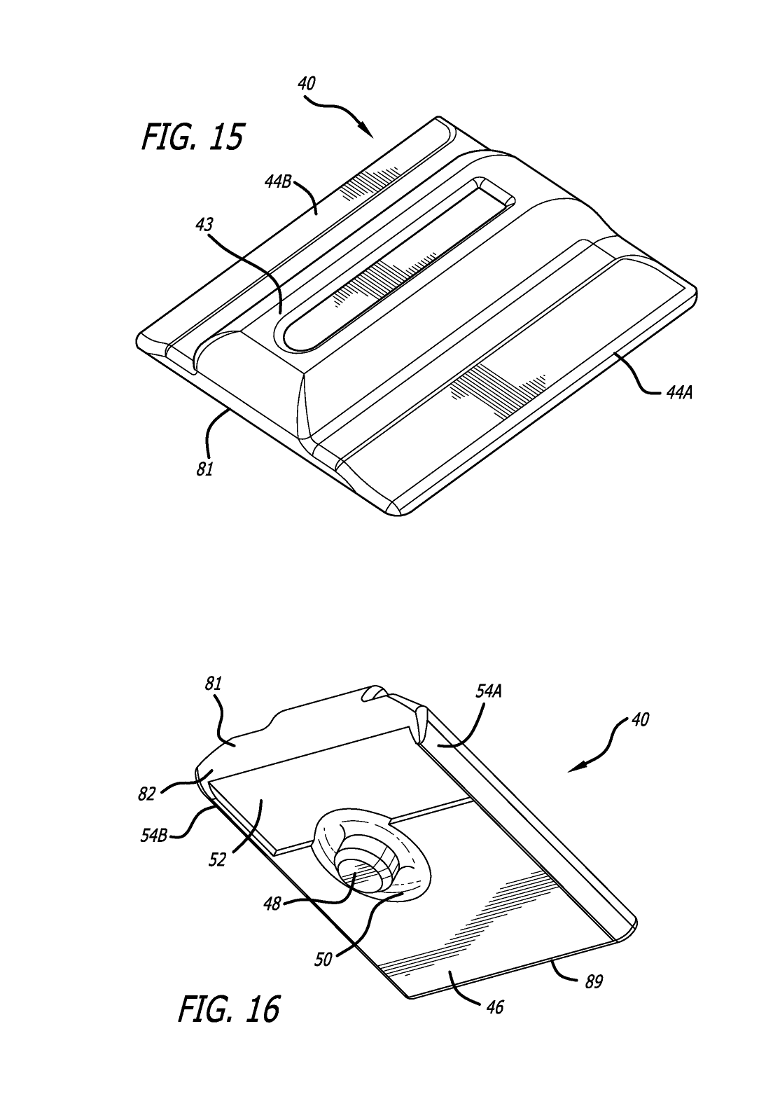

In one embodiment, as shown for example in FIG. 16, a recess 52 is formed in the bottom surface 46 of the ligating gate 40. A projecting edge 54A and 54B extend at least partially around the recess 52. The recess 52 is formed toward the leading edge 81 of the gate 40 and extends at least partially over the archwire slot and preferably extends completely over the archwire slot. The recess 54 allows for better rotational control of the archwire. When the gate 40 is in the closed position 42, the projecting edges 54A and 54B extend over the archwire and can contact the archwire 34 in a mesial-distal direction. Thus, the projecting edges 54A,54B provide two points of contact on the archwire 34 in the mesial-distal direction to improve rotational control. In one embodiment, the projecting edges 54A,54B border the recess 52 and provide two points of contact in the mesial-distal direction with the archwire 34 in an anterior section of the mouth where the archwire has a radius that is relatively tight. In this situation, the two points of contact not only improve rotational control, it allows the gate 40 to close over the archwire without overly increasing the depth of the archwire slot 32.

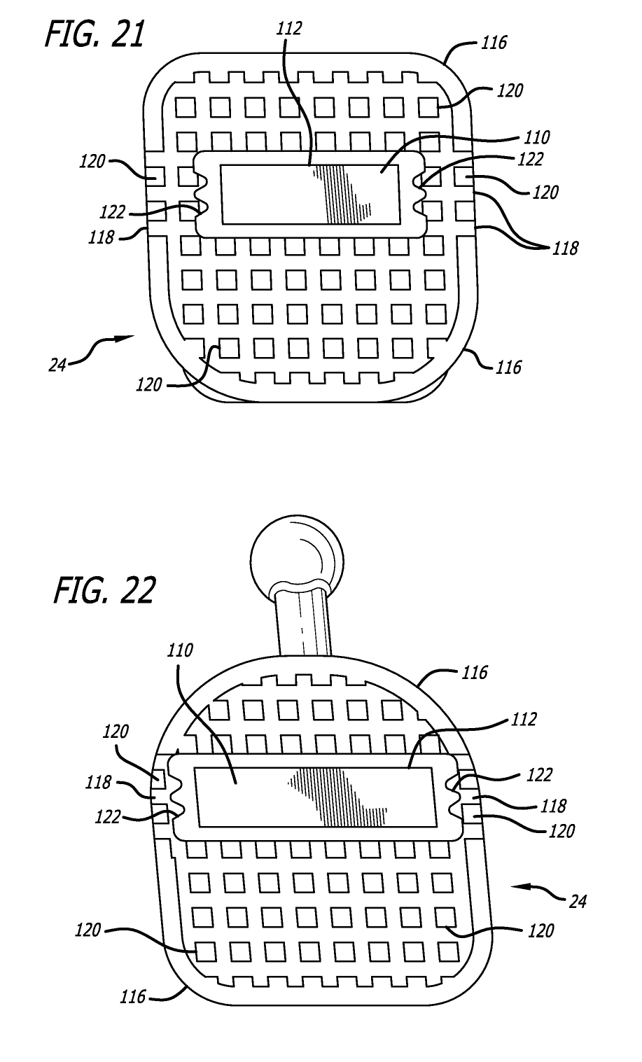

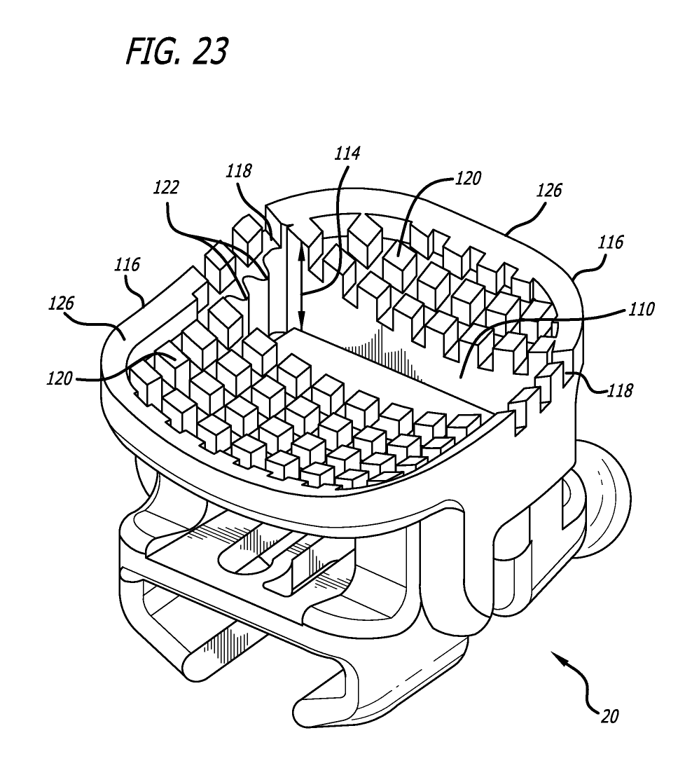

In one embodiment, as shown in FIGS. 21-23, the orthodontic bracket 20 has a bracket body 22 and a base 24. Preferably, the bracket body and base are a unitary structure that is molded by known methods of forming orthodontic brackets. For example, one preferred method of forming orthodontic brackets is to use a metal injection molding (MIM) process. In this embodiment, the base 24 has a debonding core 110 that extends through the base and partially into the bracket body 22. The debonding core 110 has a generally rectangular shape 112, however, any suitable geometric shape can be used when forming the bracket. The depth 114 (indicated by arrows) of the core 110 depends on the type of bracket and the size of the bracket, but should be of sufficient depth and shape in order to provide some flexibility to the bracket body in order to assist in debonding the orthodontic bracket from a patient's tooth.

During bonding there is excess adhesive that is expressed from under the bracket. Removing this is often called cleanup and the adhesive is removed by tracing around the perimeter of the bonding base with a probe or scaler. One-piece brackets (versus foil mesh bonding pads) can make cleanup difficult as the scaler can snag on the edges of the spaces between the protruding and recessed portions of the base. A solution to this is to have a rim around the perimeter of a one-piece bonding base, but this also can be problematic as the rim does not allow the excess adhesive easy escape during placement and can therefore trap air bubbles in the adhesive. One solution is to include a limited number of vents (voids) in the perimeter rim. This provides the benefit of the rim while providing an escape path for the adhesive and limiting the chance of snagging the scaler during cleanup. As further shown in FIGS. 21-23, rim 116 extends around the bottom of the base 24 and provides a seal for the adhesive between the base and the patient's tooth. As the bracket is mounted on the patient's tooth, some adhesive may leak out and the rim 116 permits ease of cleaning excessive adhesive from around the perimeter of the bracket base. The rim 116 has several vents 118 (gaps in rim 116) in order to specifically permit the escape of excess adhesive during the bonding process.

In order to create a better bonding surface between the base of the bracket and the patient's tooth, a number of projections 120 extend from the bottom of the base and provide an increased surface area for the adhesive to attach to. The projections 120 enhance bond reliability, resist shear loading, and increase tensile strength. In one embodiment, the surface area of the projections 120 are patterned to duplicate the surface area of an 80 gauge mesh (well known in the art), which has proven to be superior in clinical use to enhance bonding reliability. In the embodiments depicted in FIGS. 21-23, the projections 120 have a square configuration, but other geometric shapes are contemplated, such as rectangular, circular, or the like, as long as there is more surface for the adhesive to surround and provide a uniform bond. In one embodiment, the surface area of all of the bonding base, including the rim 116, vents 122, core 110 and projections 120, duplicates or equals the surface area of 80-gauge foil mesh (including the pad length, width and the surfaces of all of the wires that form the screen mesh). As an example, the projections 120 can have various shapes, depths and surface areas, as long as the surface area of all of the bonding base components is the same as the surface area of all of the components of the 80-gauge mesh. In one embodiment, the projections 120 have a square shape, with each side being 0.008 inch, the height being 0.006 inch, and 0.006 inch spacing between projections 120.

In order to more easily debond the bracket from the tooth, adhesive debonding initiators 122, shown in FIGS. 21-23, are formed in the debonding core 110. Coupled with the debonding core 110, the adhesive debonding initiators 122 permit the orthodontist to apply pressure to the corners of the base to easily debond the bracket from the patient's tooth without causing discomfort to the patient or damage to the enamel.

When mounting an orthodontic bracket on a patient's tooth, the doctor relies on several visual cues to assist in proper alignment. For example, most brackets have a diamond shape tipped at the angulation of the tooth and there typically is a longitudinal groove on the bracket between the tie wings that is aligned with the longitudinal axis of the tooth. Further, the archwire slot is used to provide vertical alignment of the bracket on the tooth. In one embodiment of the invention, these known visual alignment cues are supplemented with a tactile feedback provided by a contoured base 126, shown in FIGS. 21-23. As shown in FIGS. 1-4 and 21-23, the orthodontic bracket 20 has a bracket body 22 and a unitary base 24. In this embodiment, the tooth contoured bonding base 126 provides improved fit of the bonding base to the tooth when bonding the bracket to the patient's tooth. In other words, when the contoured bonding base 126 is placed on the tooth surface, the contour of the base provides tactile feedback to the doctor to find the height of the contour on the tooth.

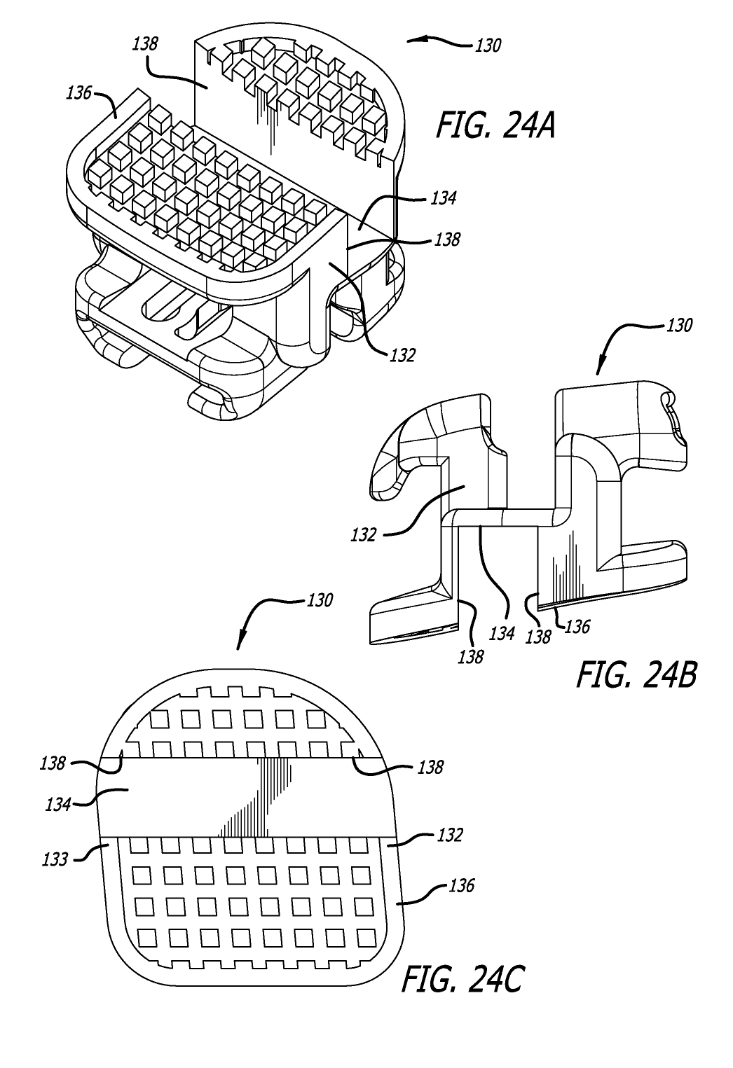

The bonding core 110 in FIGS. 21-23 provides flexibility in the bracket body and facilitates debonding the bracket from the patient's tooth without discomfort to the patient or damage to the tooth enamel. Other embodiments of a debonding core include a breakthrough or gap in which the debonding core extends all the way through the mesial and distal sides of the bracket, resulting in a breakthrough (gap) in the wall of the bracket. As shown in FIGS. 24A-24C, the orthodontic bracket 130 has a mesial side 132, a distal side 133 and a debonding core 134 in a bracket base 136. In this embodiment, a breakthrough 138 in the debonding core 134 includes the full length and width of the core. This embodiment provides substantial flexibility in the bracket body 130 so that debonding the bracket from the patient's tooth is easier and less stressful to the patient.

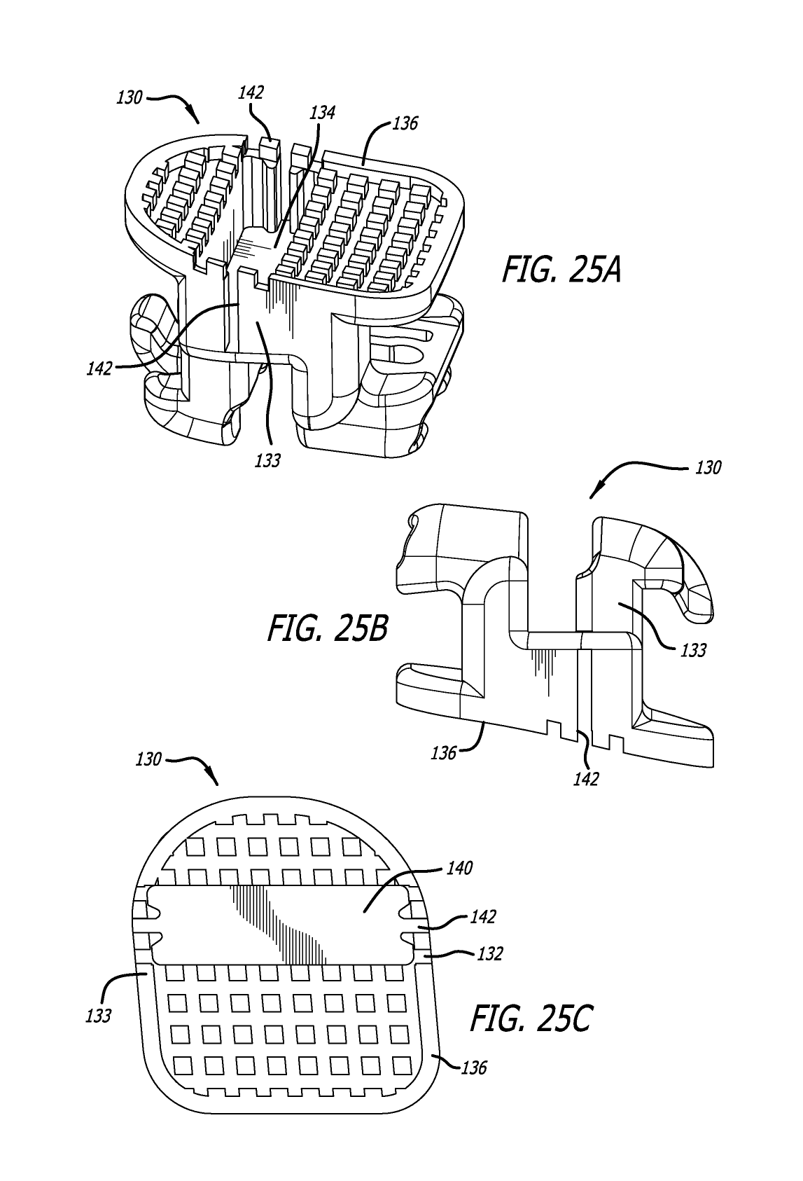

In another embodiment as shown in FIGS. 25A-25C, the bracket body 130 has a mesial side 132, a distal side 133 and a debonding core 140 in bracket base 136. In this embodiment, a breakthrough 142 in the debonding core 140 is the full depth of the core, but only a portion of the width of the core. The width of breakthrough 142 can vary and be any width short of the full width of the core 140 and it can be positioned anywhere along the width of the core and not necessarily centered as shown in FIGS. 25A-25C.

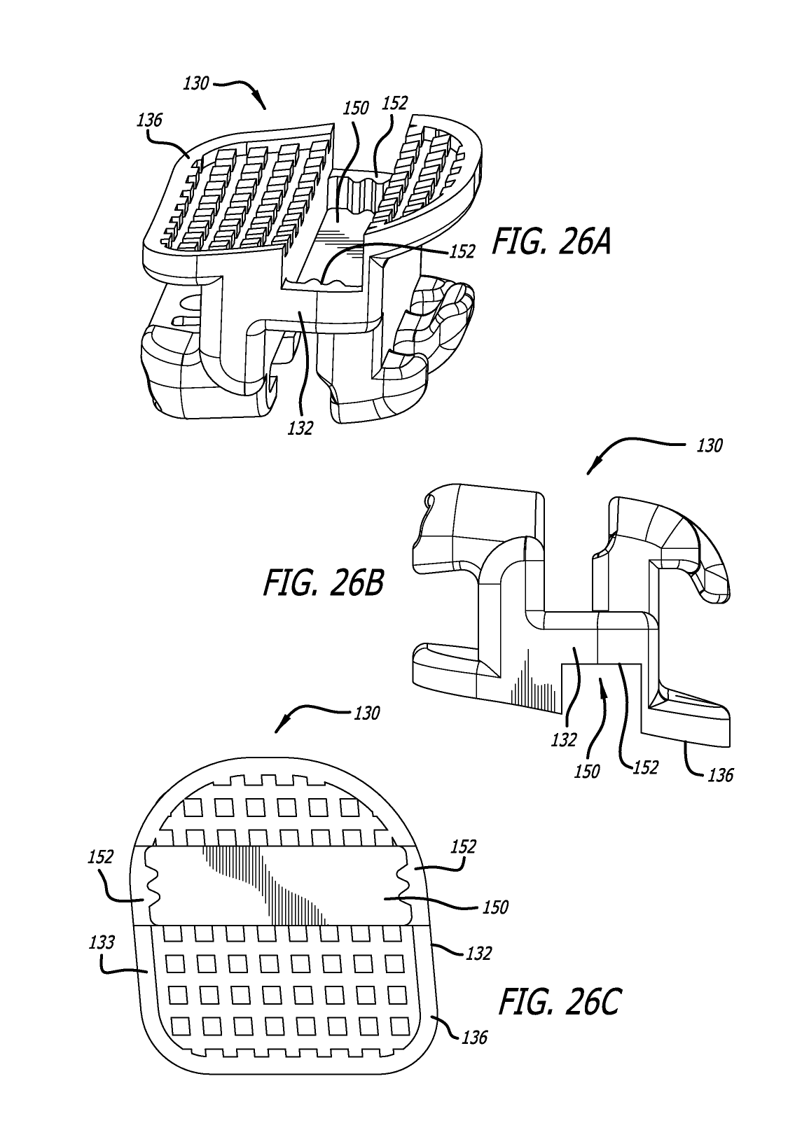

In the embodiment shown in FIGS. 26A-26C, the bracket body 130 has a mesial side 132, a distal side 133, and a debonding core 150 in bracket base 136. In this embodiment, the breakthrough 152 in the debonding core 150 is the full width of the core, but only a portion of the depth. The depth of breakthrough 152 can vary and be any depth short of the full depth of debonding core 150.

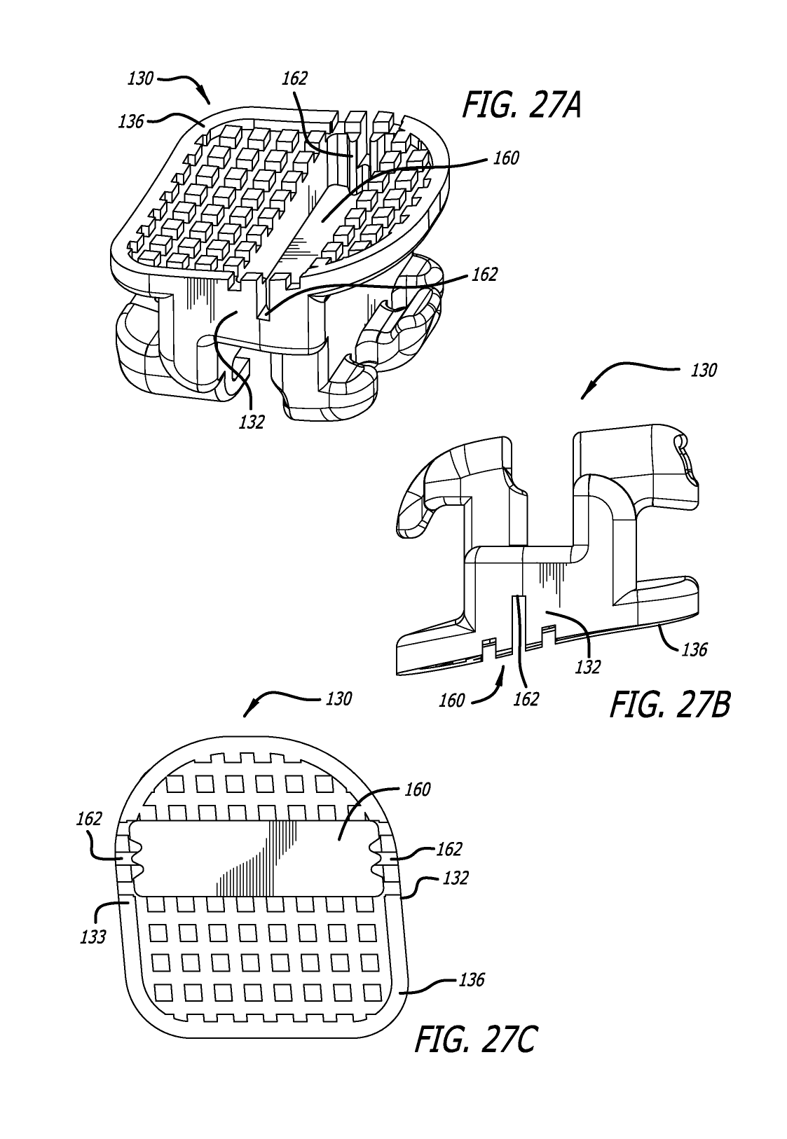

In the embodiment shown in FIGS. 27A-27C, the bracket body has a mesial side 132, a distal side 133 and a debonding core 160 in bracket base 136. In this embodiment, a breakthrough 162 in the debonding core 160 is only a portion of the depth and a portion of the width of the debonding core 160. As described for FIGS. 25A-25C and 26A-26C, the width and depth of breakthrough 162 can vary.

Importantly, in all of the embodiments depicting a debonding core as shown in FIGS. 21-27C, the shape and size of the debonding core, coupled with the size and shape of the breakthrough, provide flexibility to the bracket so that the bracket is more easily debonded from the tooth without discomfort to the patient or damage to the enamel.

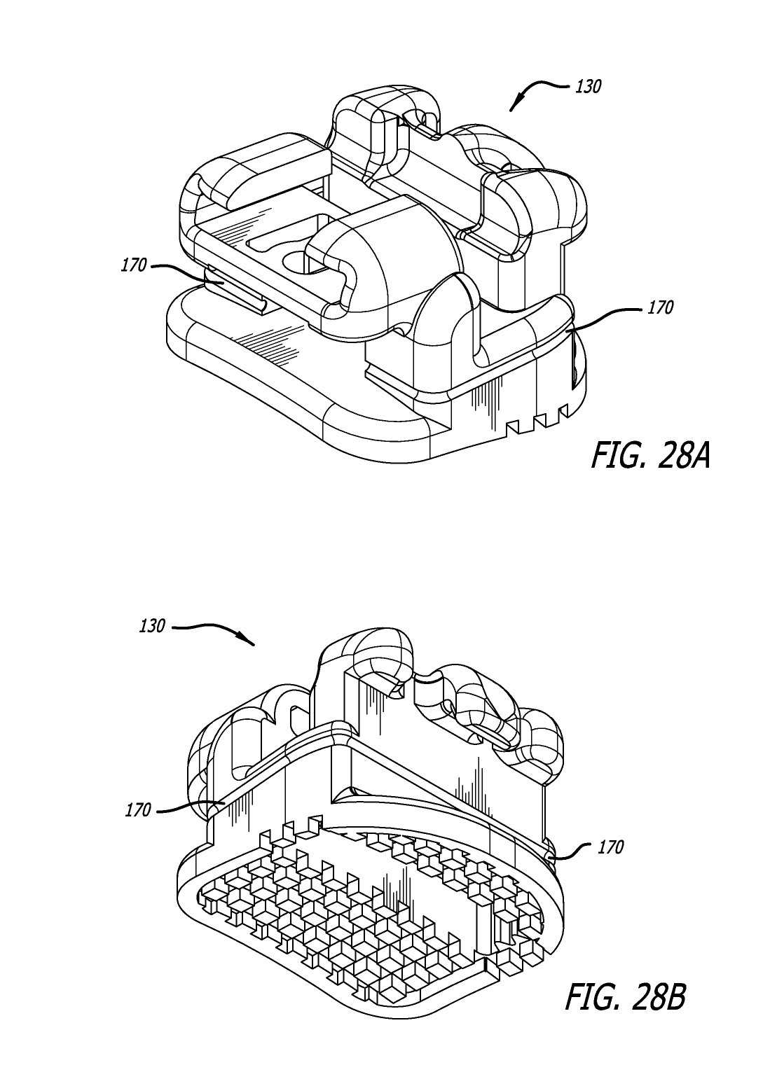

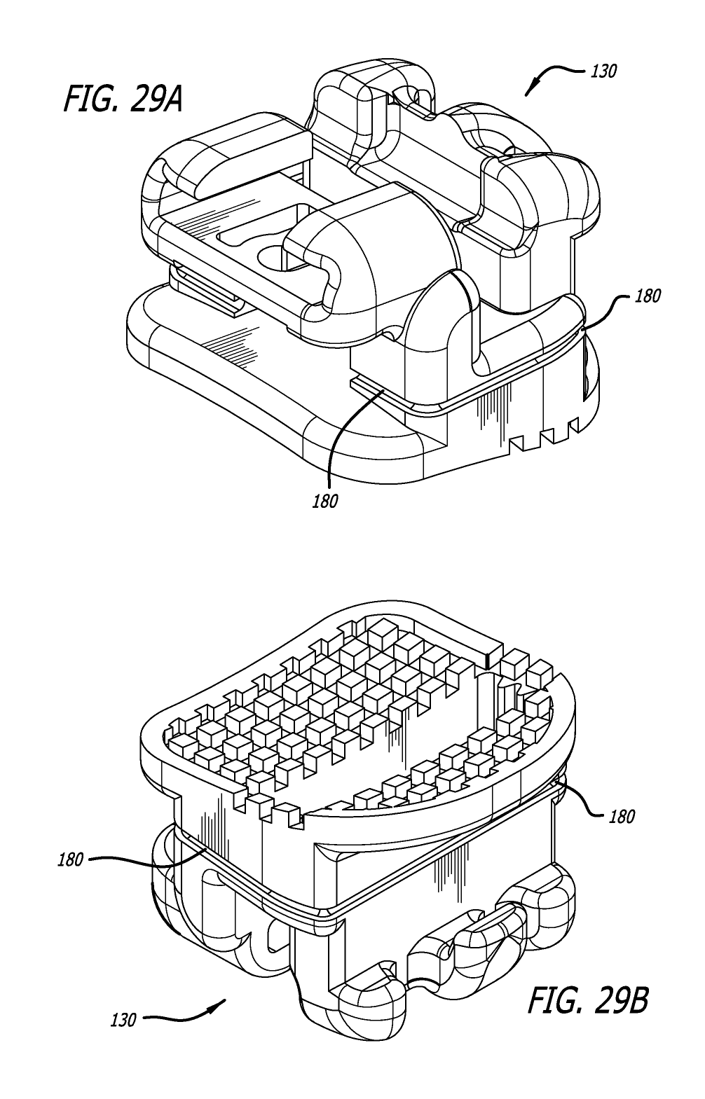

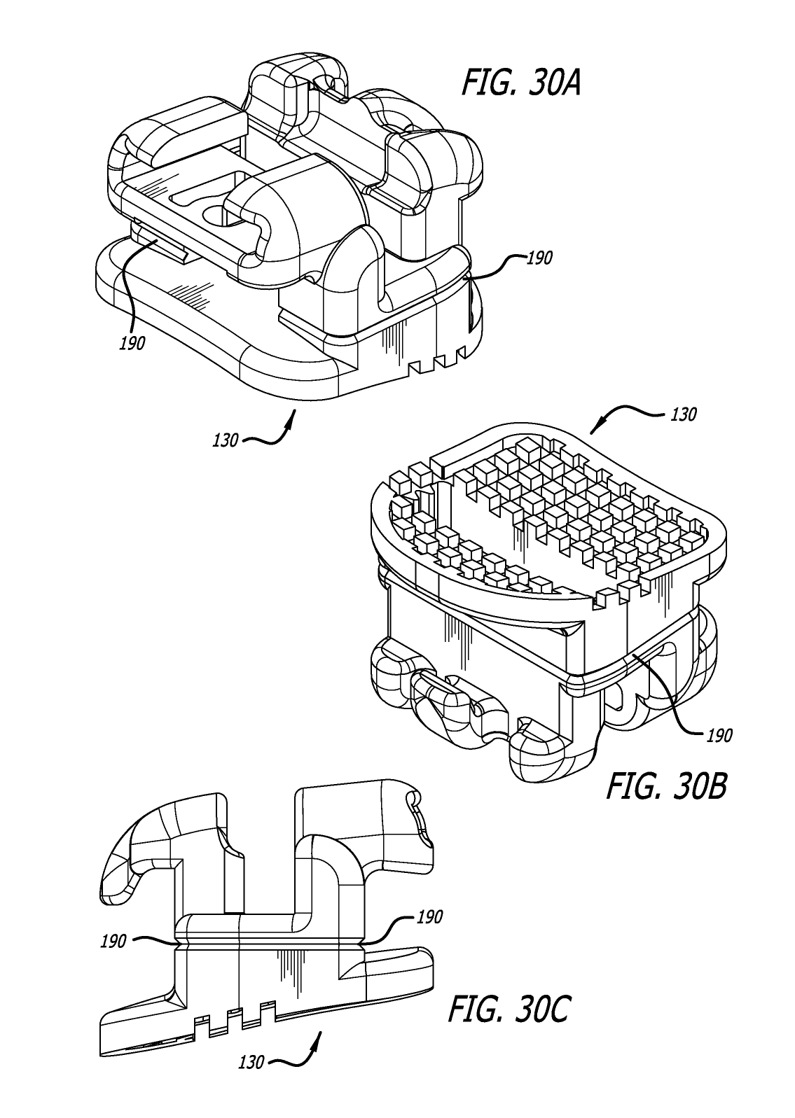

In another embodiment shown in FIGS. 28A-30C, a groove is formed in the bracket body to increase the flexibility of the bracket and enhance debonding the bracket from the patient's tooth. In FIGS. 28A-28B, the bracket body 130 has a semi-circular-shaped groove 170 extending around the bracket body. The semi-circular-shaped groove 170 can extend around the entire bracket body, or only a portion of the bracket body. In the embodiment shown in FIGS. 29A-29B, a U-shaped groove 180 extends around the bracket body 130. The U-shaped groove 180 can extend around the entire bracket body, or only a portion of the bracket body. In the embodiment shown in FIGS. 30A-30C, a V-shaped groove 190 extends around the bracket body 130. The V-shaped groove 190 can extend around the entire bracket body, or only a portion of the bracket body.

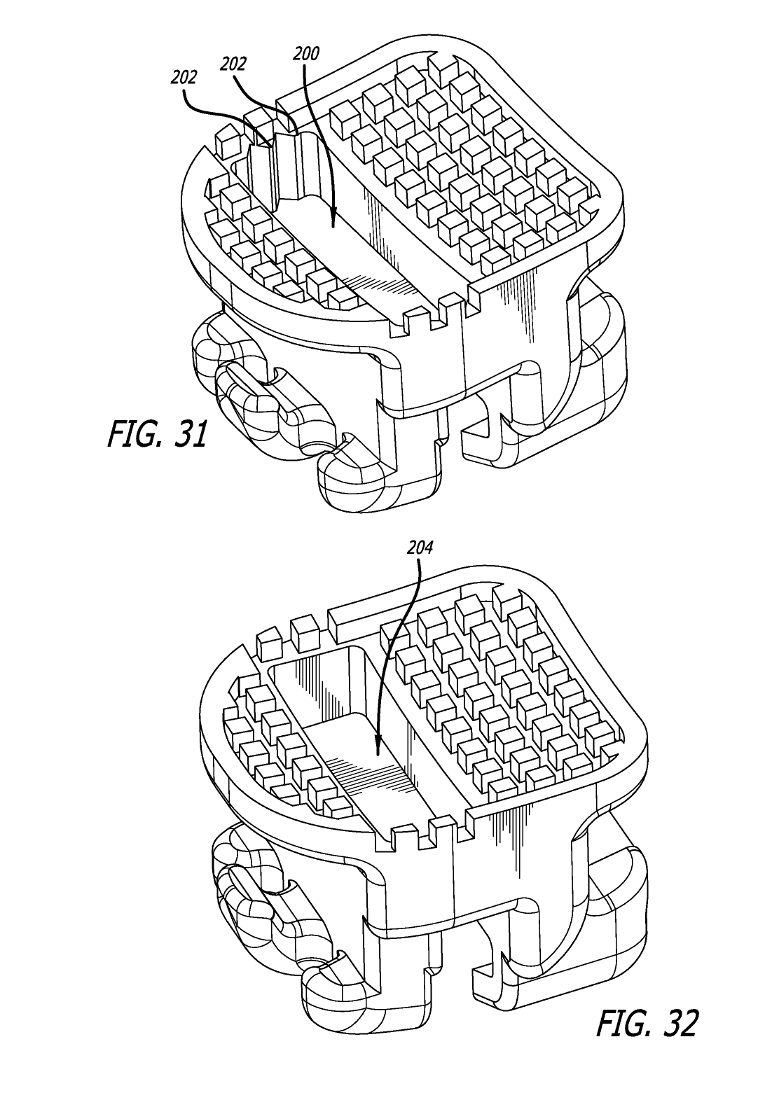

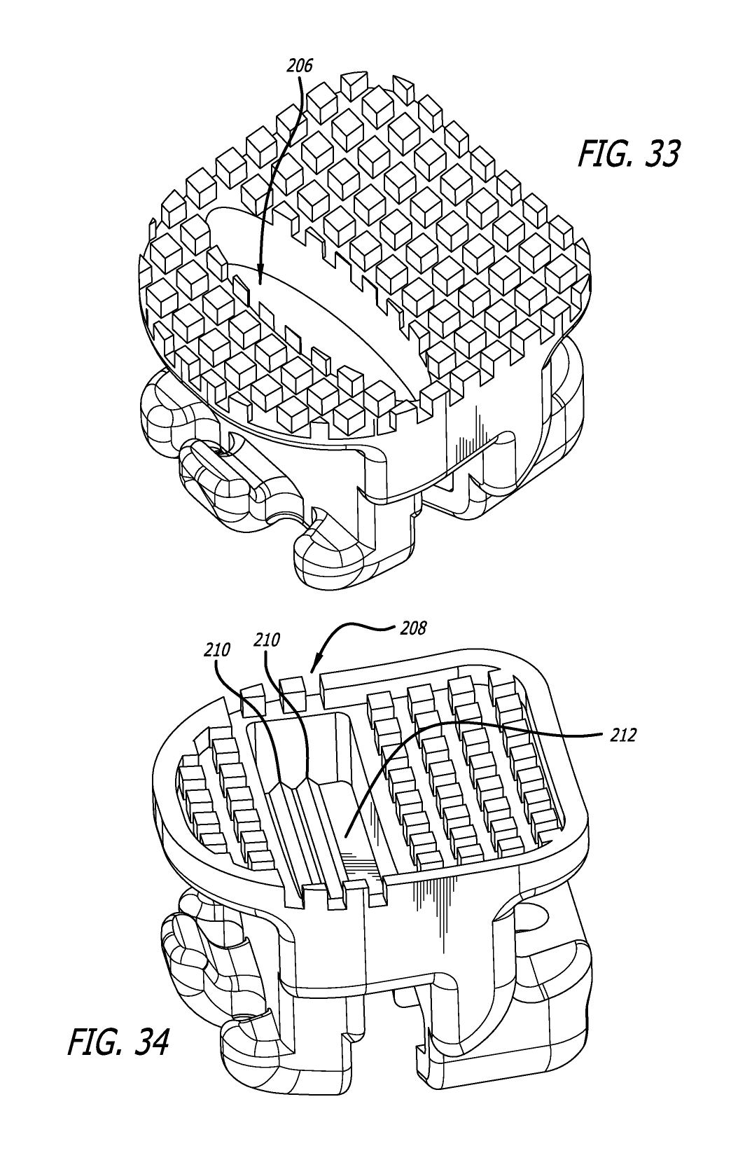

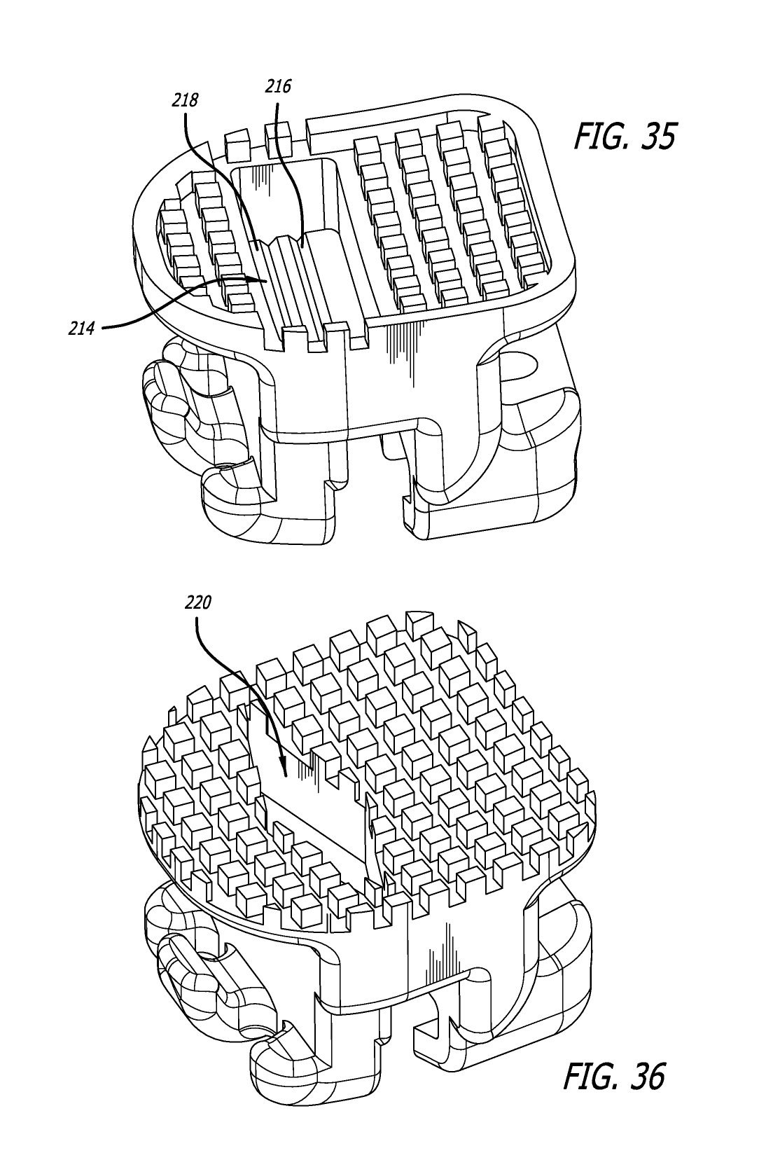

Numerous other embodiments are contemplated for the size and shape of the debonding core. In FIG. 31, the debonding core 200 is similar in size and shape to the debonding core 110 shown in FIGS. 21-23, except that the debonding initiators 202 have a V-shape, while the debonding initiators 122 in FIGS. 21-23 have a U-shape. In FIG. 32, the debonding core 204 is similar in size and shape to the debonding core 110 in FIGS. 21-23, except that the debonding core 204 has no debonding initiators 122 like those shown in FIGS. 21-23. In FIG. 33, the debonding core 206 has an elliptical shape and there is no rim such as the rim 116 shown in FIGS. 21-22. In FIG. 34, the debonding core 208 is similar in size and shape to the debonding core 110 in FIGS. 21-23, except that debonding core 208 has longitudinal ridges 210 extending along the bottom surface 212 of debonding core 208. In FIG. 35, the debonding core 214 is similar in size and shape to the debonding core 110 in FIGS. 21-23, except that debonding core 214 has longitudinal grooves 216 in the bottom surface 218 of the core. In FIG. 36, the debonding core 220 has a parallelogram shape and there is no rim around the bracket base.

It is also contemplated that the debonding core have an irregular shape and varying depths, and still be within the scope of the invention.

In order to achieve the desired flexibility in the brackets having a debonding core (FIGS. 21-36), the wall thickness of the borders surrounding the debonding cores disclosed herein range in thickness from 0.004 inch to 0.050 inch. For example, in FIG. 21, border walls 171,172 have a thickness 174 in the range of 0.004 inch to 0.050 inch.

1. A self-ligating orthodontic bracket, comprising:
a bracket body having a base for mounting on a tooth, the bracket body having an archwire slot extending in a mesial-distal direction and configured for receiving an archwire;
a gate slidably mounted on the bracket body and movable along a translational plane from an open position to permit insertion of an archwire into the archwire slot, to a closed position wherein the gate extends over the archwire slot to retain the archwire in the archwire slot;
a base plane defined by a bottom surface of a base in the archwire slot; and
wherein the translational plane is at an acute angle to the base plane.

2. The self-ligating orthodontic bracket of claim 1, wherein the gate has a radiused leading edge extending in the mesial-distal direction so that as the gate closes over the archwire, the radiused leading edge pushes the archwire into the archwire slot.

3. The self-ligating orthodontic bracket of claim 2, wherein the archwire slot has a first vertical wall and a second vertical wall extending from the base in the archwire slot, the first vertical wall having an upwardly extending radiused ledge extending in the mesial-distal direction.

4. The self-ligating orthodontic bracket of claim 3, wherein the radiused leading edge of the gate slides over the upwardly extending radiused ledge when the gate is moved to the closed position.

5. The self-ligating orthodontic bracket of claim 4, wherein the radiused leading edge of the gate extends past the first vertical wall between 0.001 inch and 0.009 inch when the gate is in the closed position.

6. The self-ligating orthodontic bracket of claim 4, wherein the radiused leading edge of the gate extends past the first vertical wall 0.005 inch when the gate is in the closed position.

7. The self-ligating orthodontic bracket of claim 1, wherein the gate has a top surface and a bottom surface, the bottom surface having a recess formed therein.

8. The self-ligating orthodontic bracket of claim 1, wherein the gate is slidably retained in the bracket body by a first retainer and a second retainer.

9. The self-ligating orthodontic bracket of claim 8, wherein the gate has a first side and a second side that come into sliding engagement with the first retainer and the second retainer.

10. The self-ligating orthodontic bracket of claim 1, wherein the bracket body has three tie-wings.

11. The self-ligating orthodontic bracket of claim 1, wherein the bracket body has a mesial shoulder and a distal shoulder for removably attaching chain elastomerics.

12. A self-ligating orthodontic bracket, comprising:
a bracket body having a base for mounting on a tooth, the bracket body having an archwire slot extending in a mesial-distal direction and configured for receiving an archwire;
a gate slidably mounted on the bracket body and movable along a translational plane from an open position to permit insertion of an archwire into the archwire slot, to a closed position wherein the gate extends over the archwire slot to retain the archwire in the archwire slot;
a post extending from a bottom surface of the gate; and
wherein the post extends into a slot in the bracket body so that as the gate moves from the open position to the closed position, and vice versa, the post slides in the slot.

13. The self-ligating orthodontic bracket of claim 12, wherein the gate has a radiused leading edge extending in the mesial-distal direction so that as the gate closes over the archwire, the radiused leading edge pushes the archwire into the archwire slot.

14. The self-ligating orthodontic bracket of claim 13, wherein the archwire slot has a first vertical wall and a second vertical wall extending from the base in the archwire slot, the first vertical wall having an upwardly extending radiused ledge extending in the mesial-distal direction.

15. The self-ligating orthodontic bracket of claim 14, wherein the radiused leading edge of the gate slides over the upwardly extending radiused ledge when the gate is moved to the closed position.

16. The self-ligating orthodontic bracket of claim 15, wherein the radiused leading edge of the gate extends past the first vertical wall between 0.001 inch and 0.009 inch when the gate is in the closed position.

17. The self-ligating orthodontic bracket of claim 15, wherein the radiused leading edge of the gate extends past the first vertical wall 0.005 inch when the gate is in the closed position.

18. The self-ligating orthodontic bracket of claim 12, wherein the gate is slidably retained in the bracket body by a first retainer and a second retainer.

19. The self-ligating orthodontic bracket of claim 18, wherein the gate has a first side and a second side that come into sliding engagement with the first retainer and the second retainer.

20. A self-ligating orthodontic bracket, comprising:
a bracket body having a base for mounting on a tooth, the bracket body having an archwire slot extending in a mesial-distal direction and configured for receiving an archwire;
a gate slidably mounted on the bracket body and movable along a translational plane from an open position to permit insertion of an archwire into the archwire slot, to a closed position wherein the gate extends over the archwire slot to retain the archwire in the archwire slot;
a post extending from a bottom surface of the gate;
a slot in the bracket body includes a spring arm and an offset keyhole; and
wherein the post extends into the slot in the bracket body so that as the gate moves from the open position to the closed position, and vice versa, the post slides in the slot and the spring arm provides slight engagement forces on the post.

21. The self-ligating orthodontic bracket of claim 20, wherein the spring arm is configured to deflect slightly as the post moves in the slot.

22. The self-ligating orthodontic bracket of claim 21, wherein the spring arm has a curved end to provide sliding relief as the post moves into or out of the offset keyhole.

23. The self-ligating orthodontic bracket of claim 22, wherein the post has a flat surface that slidingly engages the slot.

24. A self-ligating orthodontic bracket, comprising:
a bracket body having a base for mounting on a tooth, the bracket body having an archwire slot extending in a mesial-distal direction and configured for receiving an archwire;
a gate slidably mounted on the bracket body and movable from an open position to permit insertion of an archwire into the archwire slot, to a closed position wherein the gate extends over the archwire slot to retain the archwire in the archwire slot;
a first retainer and a second retainer angled at an open position to accept the gate; and
the first retainer and the second retainer having a closed position to encapsulate the gate.

25. The self-ligating orthodontic bracket of claim 24, wherein the gate is slidably retained by the first retainer and the second retainer.

26. The self-ligating orthodontic bracket of claim 25, wherein the gate has a first side and a second side that come into sliding engagement with the first retainer and the second retainer.

27. The self-ligating orthodontic bracket of claim 24, wherein the bracket body has three tie-wings.

28. The self-ligating orthodontic bracket of claim 24, wherein the bracket body has a mesial shoulder and a distal shoulder for removably attaching chain elastomerics.

29. The self-ligating orthodontic bracket of claim 24, wherein the first retainer and the second retainer are in slight frictional engagement with the gate.
